(19) United States
(12) Patent Application Publication
(10) Pub. No.: US 2016/0110677 A1
(43) Pub. Date: Apr. 21, 2016

(54) SYSTEMS AND TECHNIQUES FOR ENSURING THE INTEGRITY OF ENTERPRISE ASSET MANAGEMENT DATA

(71) Applicant: Utopia Global, Inc., Mundelein, IL (US)

(72) Inventors: Peter Aynsley-Hartwell, Dubai (AE); William Joseph Meinweiser, Lafayette, IN (US)

(21) Appl. No.: 14/983,179

(22) Filed: Dec. 29, 2015

Related U.S. Application Data
(63) Continuation-in-part of application No. 14/752,360, filed on Jun. 26, 2015.
(60) Provisional application No. 62/018,987, filed on Jun. 30, 2014.

(51) Int. Cl. G06Q 10/06; G06F 17/30

(52) U.S. Cl. CPC G06Q 10/063114; G06F 17/30365; G06Q 10/0633

(57) ABSTRACT

Systems and techniques are described for ensuring the integrity of enterprise asset management data stored in a database system. Systems include an enterprise asset management data store with enterprise asset management data entities of one or more entity type. Entity types include an equipment entity type, a functional location entity type, an MRO bill of material entity type, a work center entity type, a catalog entity type, a maintenance item entity type, a maintenance plan entity type, a measuring points entity type, a production resource/tool entity type; and a task list entity type. Each entity type includes attributes and specific update validation rules. Techniques are further provided for directing update requests for changes to enterprise asset management data entities thorough a series of work queues, each of which may operate to enforce the specific update validation rules apropos to the enterprise asset management data entities being changed.

### CROSS REFERENCE TO RELATED APPLICATIONS

This application is a Continuation-in-Part of application Ser. No. 14/752,360, filed Jun. 26, 2015, which claims benefit of provisional Application No. 62/018,987, filed Jun. 30, 2014, the entire contents of which are herein incorporated by reference.

### BACKGROUND

An important objective for enterprises is to maintain an accurate and up-to-date version of master data, given that the master data supports the operational and analytical sides of an enterprise. In order to create and maintain master data, it is desirable to ensure the integrity of data received from the various operational and analytical systems. However, master data quality issues may arise due to incomplete and/or erroneous information within data received from the various operational and analytical systems. These data quality issues can multiply as the number of operational and analytical systems in an enterprise is increased.

One way to address data quality issues is by using data governance tools to ensure proper handling of data records. Data governance tools are used to monitor data quality at each operational and analytical system and at a master data hub. An enterprise can make use of data governance tools at each system and hub, but this can lead to compartmentalization. Such use of separate tools at each system and hub fails to provide a streamlined process by which data is governed (i.e., received, handled, processed, evaluated, corrected, and made viewable) throughout all systems and hubs of an enterprise.

Enterprise resource planning systems, such as SAP® (from SAP AG), are integrated enterprise software solutions. SAP Master Data Governance (MDG) is a process-centric application that provides centralized governance for selected master data domains based on SAP's standard data models. MDG supports central maintenance processes that ensure that the master data is fit for use in SAP Business Suite processes. MDG provides out-of-the-box data models, validations, user interfaces, and workflow, and in addition also allows for customized processes in order to ensure a consistent definition and governance of master data in the organization. This, together with the distribution of the master data, can replace the often error-prone process of manually maintaining master data in multiple systems. SAP MDG provides the flexibility to extend the delivered models or to build completely new MDG applications with appropriate workflows, roles, user interfaces and validation.

### SUMMARY

Systems and techniques are described for ensuring the integrity of enterprise asset management data stored in a database system. Embodiments include an enterprise asset management data store with enterprise asset management data entities of one or more entity type. Entity types include an equipment entity type, a functional location entity type, an MRO bill of material entity type, a catalog entity type, a maintenance item entity type, a maintenance plan entity type, a measuring points entity type, a production resource/tool entity type, a task list entity type, and a work center entity type. Each entity type includes attributes and specific update validation rules.

Embodiments include techniques for directing update requests for changes to enterprise asset management data entities through a series of work queues, each of which may operate to enforce the specific update validation rules apropos to the enterprise asset management data entities being changed. Changes to enterprise asset management data entities may be stored in a temporary repository before being committed to the master enterprise asset management data store.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example component environment in which techniques and systems of the subject invention may be practiced.

FIG. 2 shows an example workflow for ensuring the integrity of enterprise asset management data in accordance with the subject invention.

FIG. 3 shows an example process flow for ensuring the integrity of enterprise asset management data.

FIG. 4 shows a block diagram illustrating components of a computing device or system used in some implementations.

FIG. 5 illustrates an example system architecture in which an implementation of techniques and systems for ensuring the integrity of enterprise asset management data may be carried out.

### DETAILED DESCRIPTION

Systems and techniques are described for ensuring the integrity of enterprise asset management data stored in a database system. Technical features of the subject invention produce advantageous technical effects in the operation of data systems. Systems and techniques operate to improve the integrity of enterprise asset management data stored within a data store and/or database system, which may improve database system reliability, performance, and data integrity within operational and analytic systems reliant upon the enterprise asset management data.

Some embodiments include an enterprise asset management data store with enterprise asset management data entities of one or more entity type. Entity types include an equipment entity type, a functional location entity type, an MRO bill of material entity type, a catalog entity type, a maintenance item entity type, a maintenance plan entity type, a measuring points entity type, a production resource/tool entity type, a task list entity type, and a work center entity type. Each entity type includes attributes and specific update validation rules. Entity types may support the operation of “plants,” which may be broadly defined to include, for example, airports, steel mills, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc. Enterprise asset management data entity types may be particularly well-suited to linear asset intensive industries, such as electricity generation and transmission, railway, and oil/gas pipeline.

Embodiments include techniques for directing update requests for changes to enterprise asset management data entities thorough a series of work queues, each of which may operate to enforce the specific update validation rules apropos to the enterprise asset management data entities being changed. Changes to enterprise asset management data entities may be stored in a temporary repository before being committed to the master enterprise asset management data store.

Some embodiments may enhance an existing master data governance system, such as the SAP® MDG system. In embodiments integrating with an existing master data governance system, the subject invention includes process flows and enterprise asset management entities including attributes and specific update validation rules that are or may be tailored to the existing master data governance system. Alternatively, it will be appreciated that the disclosed technologies may be employed to augment or otherwise to supplement systems that do not implement existing or pre-packaged master data governance systems, and may be operative in connection with any system generally known or developed in accordance with known principals that may benefit from integrated master data governance functionality.

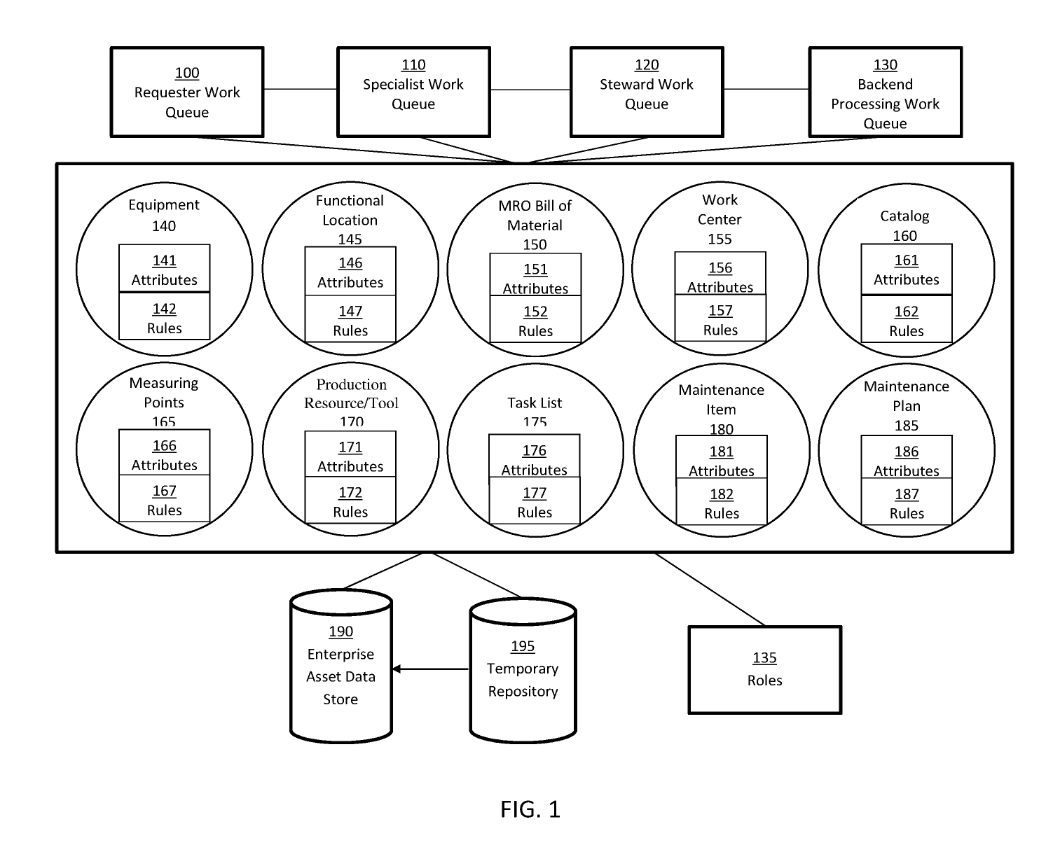

FIG. 1 shows an example component environment in which techniques and systems of the subject invention may be practiced. FIG. 1 shows queues (100, 110, 120, 130), which may be assigned security roles 135, entity types associated with entities (140, 145, 150, 155, 160, 165, 170, 175, 180, and 185) stored on or in connection with an enterprise asset data store 190, and a temporary repository 195 for storing requested changes until approved.

A work queue, generally, is a holding place in a workflow process where requests await further processing, approval, and/or rejection. A work queue may be accessed by a user interface of an application, and the data or metadata required for storing a request's position in the workflow (e.g., presence in a work queue) can be stored in a separate data store. It will be appreciated that the representation of FIG. 1 is provided by way of example only, and not by way of limitation, and that certain functional elements are not illustrated for the sake of clarity.

Work queues described herein are of four types, requester 100, specialist 110, steward 120, and backend processing 130. Each work queue represents a holding point where a request to update enterprise asset data may undergo review, approval, rejection, return to a prior queue, and/or final backend processing. A work queue of a particular type has a “role” associated with the queue that defines the behaviors the work queue can perform. Security logins associated with individual users/groups control access to the user interface of the queue, allowing users to access the queue and perform the role's behaviors by virtue of their being members of the role that attaches to the queue. For example, an authorized and authenticated user “John” may access the requester work queue user interface by having the role “requester” associated with his user login credentials. Data or metadata associated with the role may be stored in a component 135, which may include a data store.

A requester queue 100 having a requester role has the security attributes to request a change to enterprise asset management data, but not to approve and enact the change. A requester role is deployed to users who request new enterprise asset data or updates to existing enterprise asset data.

A specialist queue 110 having a specialist role has the security attributes to, for example, approve an update request, modify the data elements that are part of the update request, or return the request to the requester for further processing. The specialist role is deployed to users who have in-depth knowledge of the enterprise asset management data entities placed under governance. More than one specialist queue 110 may exist in a given instance or implementation, as for example when different queues associated with different departments have specific domain knowledge about a subset of the enterprise asset management data.

A steward queue 120 having a steward role has the security attributes to, for example, approve an update request so that the change request stored in the temporary data repository 195 can be enacted in the enterprise asset data store 190, or return the request to a prior queue for further processing. The steward role is deployed to users who have custodial responsibility for the enterprise asset management data entities placed under governance. More than one steward queue 120 may exist in a given instance or implementation, as for example when different queues associated with different departments have specific data stewardship over a subset of the enterprise asset management data.

A backend processing work queue 130 having a backend processing role has the security attributes to update the enterprise asset data store 190 with the pending change request in the temporary data repository 195.

Techniques and systems ensure the integrity of enterprise asset management data stored with respect to certain entity types. Entity types, here, are representations of a physical or conceptual entity useful in the management of enterprise asset management data. Entity types described herein include an equipment entity type, a functional location entity type, an MRO bill of material entity type, a catalog entity type, a maintenance item entity type, a maintenance plan entity type, a measuring points entity type, a production resource/tool entity type, a task list entity type, and a work center entity type.

An entity type describes the attributes (also known as “properties”) of an entity. The totality of the individual values of the attributes for a specific instance of an entity is sometimes called the entity's “state.” Whereas the entity type describes the overall characteristics of the entity, the values of the attributes, or state, define the entity. In some instances, certain attributes can have a “null” value when the attribute does not pertain to the type of asset.

A definition of an entity type may be housed in an enterprise asset data store 190. A definition of an entity type can be implemented in a variety of ways in an enterprise asset data store. For example, an entity type can be implemented as a database table in a relational database. Each column of the table can describe an attribute of the entity. Each row of the table represents a specific instance of the entity; the intersection of the attribute (column) and the entity (row) defines a cell in which the specific value of a specific attribute for that entity is stored. Storage of an entity can also be implemented as Extended Markup Language (XML) elements and attributes in accordance with an XML Schema definition. The XML script may be stored in files stored in a file system. In some cases, an entity type may relate or refer to other entity types that may be stored in other database tables or XML descriptions.

Entity type definitions may be implemented as part of an existing data governance system having additional support entities, workflow processes, or user interface applications. An example of an existing data governance system is SAP MDG®. Other methods of defining an entity type are possible, as a practitioner in the art will recognize.

An entity type may include “rules” (or “update validation rules”) that define restrictions on the modification of the enterprise asset management data encapsulated by that entity type. The rules may define logic that must be enforced before any update request is allowed. Business rules may be individually associated with each entity type to perform activities such as: calculation of costs, overhead, and risks; matching responsibilities, suitable products, and locations; and detection of invalid relationships between data. A rule may be implemented as a set of expressions that are assigned to a function defining the operation of the rule.

In some cases, the rules may define data validation rules pertaining to the type of data entered. For example, a data validation rule may require that data entered into a “price” attribute be entered as a decimal number.

In the case of either business or data validation rules, each type of work queue may have a particular subset of rules pertaining to the role associated with the queue and the entities being changed. An update request may violate no rules, or it may violate one or more rules. A rule that is violated may have one or more behaviors associated with it, including: displaying text or description of the rule in a user interface of an application, displaying a remedial action the role can perform on the update request to remediate the rule violation, and returning the update request to a prior queue.

One kind of enterprise asset management data entity is an “equipment entity” 140. A particular equipment entity 140 describes a single physical object that is maintained as an autonomous unit. A non-exhaustive list of individual physical objects that may be maintained as an autonomous unit includes means of production (such as a machine), means of transport (such as a conveyor), test equipment, production resources/tools, customer devices, buildings, property, systems, system parts, and vehicles. Examples include point-oriented objects, line-oriented objects, and area-oriented objects. Point-oriented objects can be, for example, transformers, stations, poles, HV towers, points, valves, lights, signals, and pumps. Line-oriented objects can be, for example, circuits, grids, sections, highways, streets, tracks, systems, and pipes. Area-oriented objects can be, for example, real property such as fields or lots, counties, right-of-ways, dams, and forests.

An enterprise asset management system installed at a particular organization, for example, stores the multiplicity of equipment entities which is under management by the organization. A pipeline company, for example, may own a pipeline reaching from a place in Louisiana to a place in Texas. The pipeline is made up of a multiplicity of segments or sections of pipe. Each section of pipe is a particular instance of an equipment entity of the equipment entity type. Naturally, a pipeline is only a non-limiting example of an equipment entity; another non-limiting example is an electric power distribution utility.

As noted, each entity type has attributes. Table 1A shows an example of the attributes 141 of an equipment entity type used in some embodiments. An embodiment of an equipment entity type 140 can have, for example, attributes 141 specifying an equipment number, an equipment class, asset number, serial number, manufacturer, purchase date, model number, dimensional and weight characteristics, warranty information, last maintenance date, etc. Every instance of an equipment entity 140 has a combination of specific values for each of these attributes 141, e.g., an electric motor manufactured by General Electric, serial number P374895, purchased on Jan. 1, 1990, model number P1239. However, the attributes in Table 1A are not intended to be limiting as to either attribute name or attribute description.

An embodiment of an equipment entity type 140 can also define rules 142. Table 1B shows an example of rules 142 used in some embodiments. Table 1B shows the rule identifier, description, and message text displayed for each rule. For example, rules 142 can include rules for valid data entry (e.g., a rule that dates have to be in a certain range or format) or that data should have a certain relationship to other data (e.g., that an equipment must be installed at the same functional location at which its maintenance is performed). However, the rules in Table 1B are not intended to be limiting as to rule name, description, or message.

Another kind of enterprise asset management data entity is a “functional location entity” 145. Functional locations are hierarchically ordered structures that represent a technical system, building, or part thereof. One purpose of creating a functional location is to structure a technical system or building into units that are relevant for plant maintenance. A functional location entity type 145 comprises data describing a place at which a maintenance task is performed; the place can be described according to functional, process-oriented, or spatial criteria. Places defined according to spatial criteria may have various spatial attributes, for example, map coordinates, addresses, GPS locations, or positions within a schematic diagram of a system. Places defined according to functional criteria may delineate a location where a particular function is performed, for example a department, or a work station on a factory floor. Places defined according to process-oriented criteria may describe, for example, a stage in a workflow process or lifecycle. Equipment entities 140 may be located at one or more functional locations described by a functional location entity 145.

Table 2A shows an example of the attributes 146 of a functional location entity type 145 used in some embodiments. An embodiment of a functional location entity type 145 can have, for example, attributes 146 specifying a work center, settlement order, plant section, company code, acquisition date, acquisition value, year of construction, person responsible, etc. However, the attributes in Table 2A are not intended to be limiting as to either attribute name or attribute description.

An embodiment of a functional location entity type 145 can also define rules 147. Table 2B shows an example of rules 147 used in some embodiments. Table 2B shows the rule identifier, description, and message text displayed for each rule. For example, rules 147 can include rules for valid data entry (e.g., that an acquisition value should not be entered without a description) or that data should have a certain relationship to other data (e.g., that values for a plant section attribute should not be entered without a plant identifier). However, the rules in Table 2B are not intended to be limiting as to rule name, description, or message.

Another kind of enterprise asset management data entity is a “MRO Bill of Material” entity 150. An MRO Bill of Material entity type 150 comprises data describing a quantity, a unit of measure, and a description of one or more components that make up a physical object. These components may be known as BOM Items, which may be defined as a separate entity type. An example of a MRO Bill of Material is a parts manifest for repairing an object being maintained. For example, if a MRO Bill of Material entity pertains to a parts list for a pump overhaul that is performed yearly, BOM items that are components of the pump might include a gasket, o-rings, solenoid, a sealant, and replacement nuts and bolts.

One can use bills of material for different reasons in a company, each of which are contemplated by the present disclosure. Different uses are distinguished depending on the company area, for example:—the engineering/design BOM includes all parts of the product from an engineering/design perspective and contains their technical data. It is not usually order-specific. The production BOM includes the items from a production perspective and assembly statuses. For example, the assembly might only require production-relevant items with process-oriented data. The costing BOM represents the product structure and forms the basis for the automatic determination of material usage costs for a product. Items not relevant for costing are not included in this bill of material. The maintenance bill of material is different from the others in that it only contains items relevant to maintenance. The maintenance bill of material has two main functions: (1) Structuring of object—an object should be structured as clearly as possible from a maintenance view; (2) Spare parts planning in order—if a bill of material is available for a maintenance object, this can be used easily during the planning of a maintenance order to plan spare parts.

The material BOM is created with a direct link to a material master record. The material master record includes descriptive data (for example, measurements and weight) and control data (for example, material category and industry). The material BOM contains the individual parts of the object (materials or assemblies).

The equipment or functional location BOM is used to describe the structure of a piece of equipment or functional location and assign spare parts to it for maintenance.

Table 3A shows an example of the attributes 151 of an MRO Bill of Material entity type 150 used in some embodiments. An embodiment of an MRO Bill of Material entity type 150 can have, for example, attributes 151 specifying base quantity, base unit of measure, bill of material identifying number, and validity date range. Table 3B shows an example of the attributes of a BOM Item used in some embodiments. A BOM Item entity type can have, for example, attributes specifying the item's price and whether it is maintained as spare parts or must be ordered. However, the attributes in Table 3A and 3B are not intended to be limiting as to either attribute name or attribute description.

An embodiment of an MRO Bill of Material entity type 150 can also define rules 152. Table 3C shows an example of rules 152 used in some embodiments. Table 3C shows the rule identifier, description, and message text displayed for each rule. For example, rules 152 can include rules for valid data entry (e.g., a rule that dates have to be in a certain range or format) or that data should have a certain relationship to other data (e.g., that a material cannot be both “cost relevant” and “bulk material”). However, the rules in Table 3C are not intended to be limiting as to rule name, description, or message.

Another kind of enterprise asset management data entity is a “work center entity” 155. A work center entity type 155 comprises data describing where and when an activity is performed.

The basic data contains general data, such as work center category, description, responsibility, and usage. A work center has an available capacity. The activities performed at or by the work center are valued by charge rates, which are determined by cost centers and activity types. Work center links provide the connection between work centers and other objects. Work center may be linked to the following objects: cost center, qualifications, staffing positions, and people. Work centers can be, for example, machines, people, production lines, and groups of craftsmen.

For example, functions of the work center entity may include costing, scheduling, capacity planning. One can use costing to determine the costs of an internal activity by a product unit. The aim of costing is to attribute the costs incurred to the individual cost objects. It uses the work center to link the operation to cost accounting by maintaining cost centers and activity types. If the work center is used in an operation, standard values can be entered for the activity types specified in the work center. One can use scheduling to determine the dates when operations should be performed. For this, the time required for the operations must be calculated and compared with the time available in the work center. The standard values and quantities in the operations are used as the basis for this calculation. During scheduling, the start and end dates for the operations are calculated from this data using formulas, which are entered for scheduling purposes in the work centers. In capacity planning, the capacity requirements for the operations in the orders are determined and compared with the available capacity defined in the work center. During capacity planning, one can use work center hierarchies to aggregate the available capacity and capacity requirements of lower-level work centers at higher-level work centers.

Table 4A shows an example of the attributes 156 of a work center entity type 155 used in some embodiments. An embodiment of a work center entity type 155 can have, for example, attributes specifying a work center identifier, capacity, formula for the duration of processing time, formula for setup time, unit of measure of the work, etc. However, the attributes in Table 4A are not intended to be limiting as to either attribute name or attribute description.

An embodiment of a work center entity type 155 can also define rules 157. Table 4B shows an example of rules 157 used in some embodiments. Table 4B shows the rule identifier, description, and message text displayed for each rule. For example, rules 157 can include rules for valid data entry (e.g., a rule that dates have to be in a certain range or format) or that data should have a certain relationship to other data (e.g., that certain capacities are required for certain work center subtypes). However, the rules in Table 4B are not intended to be limiting as to rule name, description, or message.

Another kind of enterprise asset management data entity is a “catalog entity” 160. In the catalog profile, code groups can be defined and can be used when processing a specific object. The advantage here is that only the code groups relevant for the object are displayed. Catalog entity is a combination of code groups, grouped together according to content (for example, damage and cause of damage). Code groups, or combination of code groups, are grouped together according to content (for example, damage to vehicles, pumps, motors) or mechanical damage and electrical damage. The codes comprise a description of damage and activity. Advantages of the catalog entity include reduction in number of incorrect entries, codes can be used as the starting point for workflow and follow-up actions, and statistical evaluations are possible using the standard analyses.

Table 5A shows an example of the attributes 161 of a catalog entity type 160 used in some embodiments. An embodiment of a catalog entity type 160 can have, for example, attributes 161 specifying a code group, a catalog description, status of code group, usage indicator, a catalog profile, etc. However, the attributes in Table 5A are not intended to be limiting as to either attribute name or attribute description.

An embodiment of a catalog entity type 160 can also define rules 162 as described previously herein.

Another kind of enterprise asset management data entity is a “measuring points entity” 165. Measuring points are physical and/or logical locations at which a particular condition is described, for example, the temperature of coolant in a nuclear power station after an outflow from the pressure vessels or the number of rotations per minute of the rotary blades of a wind-driven power station. Measuring points are located at technical objects or equipment, and in that sense may be associated with or correlated with equipment entity types mentioned above. Counters are resources that enable the representation of the wear and tear of an object (i.e., equipment) or the consumption or reduction in its useful life, for example, the mileage indicator of a motor vehicle or the electricity consumption meter of an electrically-powered system. Counters are located at technical objects. Measurement or counter readings can be entered for each object to be maintained. This makes sense if one wants to document the condition of an object based on measurement readings or if the regular maintenance of an object depends on its meter readings. Table 6A shows an example of the attributes 166 of a measuring points entity type 165 used in some embodiments. An embodiment of a measuring points entity type 165 can have, for example, attributes 166 specifying an equipment object, object description, measuring point category, category description, etc. However, the attributes in Table 6A are not intended to be limiting as to either attribute name or attribute description.

An embodiment of a measuring points entity type 165 can also define rules 167 as described previously herein.

Another kind of enterprise asset management data entity is a “production resource/tool entity” 170. Unlike machines and fixed assets, production resources and tools (PRTs) are movable (not stationary) operating resources that are required to perform an activity and can be used repeatedly. For example, PRTs may include documents, engineering drawings, jigs and fixtures, and measurement instruments. Production resources/tools can be assigned to internal and external activities. The assignment can be used to determine the quantity, the operating time, and/or the dates of the PRTs required to carry out the activity. There are several categories of production resources and tools. The category determines the characteristics and business functions that a PRT can have. Production resources/tools may have the following categories. (1) A material PRT has its own material master record with the view “PRT”. A material PRT can be procured, that is, it can either be purchased or produced. It can be kept in stock and track both its value and quantity. (2) A miscellaneous PRT has its own PRT master record and can neither be procured nor kept in stock. (3) A document PRT has its own document info record, (for example engineering drawings or NC programs). These PRTs may be managed using the R/3 Document Management System. (4) An equipment PRT has its own equipment master record and has the full equipment functionality. This category is particularly useful for those production resources or tools which must be maintained individually or which must be serviced at regular intervals. With the equipment category, one can furnish proof of service or usage values for the production resource/tool.

As noted, each entity type has attributes. Table 7A shows an example of the attributes 171 of a production resource/tool entity 170 used in some embodiments. An embodiment of production resource/tool entity type 170 can have, for example, attributes 171 specifying an authorization group, task list usage, base unit of measuring, plant, location, setup start date, execution start date, etc. However, the attributes in Table 7A are not intended to be limiting as to either attribute name or attribute description.

An embodiment of a production resource/tool entity type 170 can also define rules 172 as described previously herein.

Another kind of enterprise asset management data entity is a “task list entity type” 175. Examples of task lists, which may be distinguished by an indicator, include an equipment task list (E), a task list for function location (F), and general maintenance task lists (G). Equipment task lists are object-based and created for a specific, individual piece of equipment (example: steps for calibrating measuring device M-105). Task lists for functional locations are also object-related and created for a specific functional location (example: steps for inspecting hydraulic press HP-200). General maintenance task lists are general task lists without object reference (example: general steps for pump maintenance). The task list types can be used for routine and preventive maintenance.

As noted, each entity type has attributes. Table 8A shows an example of the attributes 176 of a task list entity 175 used in some embodiments. An embodiment of a task list entity type 175 can have, for example, attributes 176 specifying planning plant, work center plant, planner group, maintenance strategy, inspection points, etc. However, the attributes in Table 8A are not intended to be limiting as to either attribute name or attribute description.

An embodiment of a task list entity type 175 can also define rules 177. Table 8B shows an example of rules 177 used in some embodiments. Table 8B shows the rule identifier, description, and message text displayed for each rule. For example, rules 177 can include rules for task list group naming, task list status processing, task list worker estimates, etc. However, the rules in Table 8B are not intended to be limiting as to rule name, description, or message.

Another kind of enterprise asset management data entity is a “maintenance item entity type” 180. A maintenance item describes which preventive maintenance tasks should take place regularly at a technical object (i.e., equipment) or a group of technical objects. A maintenance item could, for example, be “perform safety test”. The reference objects are then assigned exactly (for example, equipment, functional locations or assemblies) to a maintenance item at which it is desired to perform the maintenance task “safety test”.

For some call objects (for example, maintenance order or service order), the activities that are necessary for the maintenance item “Perform safety test” using a maintenance task list, which is assigned to the maintenance item, can be described. If, for example, the system generates a service order for a due date, the operations will be copied from the task list to the service order.

As noted, each entity type has attributes. Table 9A shows an example of the attributes 181 of a maintenance item entity used in some embodiments. An embodiment of a maintenance item entity type 180 can have, for example, attributes 181 specifying maintenance item category, item in the maintenance plan, automatic task determination, change indicators, etc. However, the attributes in Table 9A are not intended to be limiting as to either attribute name or attribute description.

An embodiment of a maintenance item entity type 180 can also define rules 182. Table 9B shows an example of rules 182 used in some embodiments. Table 9B shows the rule identifier, description, and message text displayed for each rule. For example, rules 182 can include rules for order types, priorities, maintenance item description, functional location, etc. However, the rules in Table 9B are not intended to be limiting as to rule name, description, or message.

Another kind of enterprise asset management data entity is a “maintenance plan entity type” 185. A maintenance plan may include a single cycle plan, a strategy plan, and multiple counter plan; each of these may be time-based and/or performance-based.

For example, in accordance with industry norms, portable fire extinguishers must be inspected every two years. Since this inspection is regulated by law, exactly the same activities must be performed each time. Inspections should be planned using a maintenance plan with a fixed maintenance cycle, which automatically triggers a suitable task on the date of the inspection. This task contains all the necessary worksteps and relevant planning data. There are three exemplary scenarios: internal processing—call object “order, internal processing—call object “notification”, and external processing—call object “service entry sheet.” For internal processing—call object “order,” the maintenance plan generates a maintenance order, which contains all the worksteps to be performed and the required materials. When the task has been completed, the technical details and costs can be verified and updated. Since not every inspection results in a repair task, it is also possible to have a request (notification) generated for the maintenance plan instead of an order. This request can be converted into an order, if required. If no repair is performed, the costs of the inspection should not be tracked. For external processing—call object “service entry sheet,” the inspection should be performed by an external company with reference to a framework agreement. The sold-to-party can use the maintenance plan to obtain an exact overview of the due dates. The maintenance plan generates service entry sheets, which may be made available to the service provider for entering the services provided.

As noted, each entity type has attributes. Table 10A shows an example of the attributes 186 of a maintenance plan entity 185 used in some embodiments. An embodiment of a maintenance plan entity type 185 can have, for example, attributes 186 specifying scheduling periods, factory calendars, units in scheduling intervals, etc. However, the attributes in Table 10A are not intended to be limiting as to either attribute name or attribute description.

An embodiment of a maintenance plan entity type 185 can also define rules 187. Table 10B shows an example of rules 187 used in some embodiments. Table 10B shows the rule identifier, description, and message text displayed for each rule. For example, rules 187 can include rules for maintenance strategy, maintenance plan control parameters, scheduling, authorizations, etc. However, the rules in Table 10B are not intended to be limiting as to rule name, description, or message.

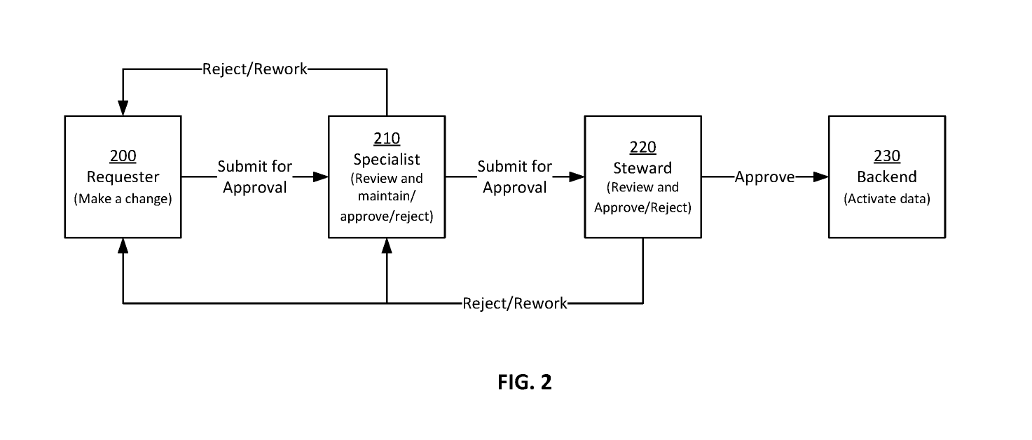

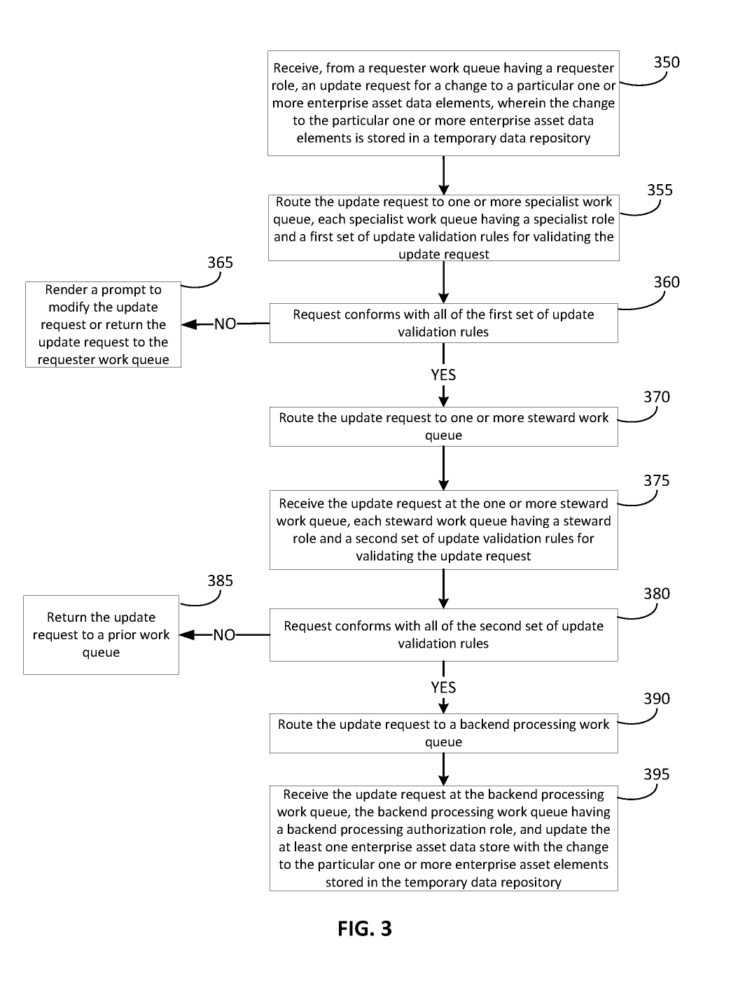

FIG. 2 shows an example workflow for ensuring the integrity of enterprise asset management data in accordance with the subject invention. FIG. 2 shows a basic view of the process flow activities that are explored in greater detail in FIG. 3.

Initially, a requester queue 200, having a requester role which can be associated with a user login, indicates a change in enterprise asset management data relating to an enterprise asset data entity. For example, an employee in the operations management department of a factory might need to modify the model number of a pump installed at the factory. The employee may enter a user interface rendered by an application for managing a requester work queue, search for the pump through the interface, and indicate that an update to a data element is desired via the user interface. The employee makes the change to the pump model number and saves the change, which records the change in a temporary data repository as the change moves through the workflow.

The update request is routed to a specialist queue 210, having a specialist role. A specialist role, in the specific pump example, could be, e.g., a higher level employee in the operations department or a technical supervisor. The specialist reviews the requested change and is notified via the user interface of any update validation rules which were violated. Depending on the validation errors, the specialist can accept the changes, further modify the data, or return the update request to the requester queue for further processing. Though the workflow illustrated in FIG. 2 is simplified to show only one specialist queue, the request could in some instances be routed to multiple specialists, in series or in parallel.

If the change is acceptable, the update request is routed to a steward queue 220. A steward role, in the specific pump example, could be, e.g., a data manager in the information technology department. The steward reviews the requested change and is notified via the user interface of any update validation rules which were violated. Depending on the validation errors, the steward can accept the changes or return the update request to the requester queue or to one or more of the specialist queues for further processing. Though the workflow illustrated in FIG. 2 is simplified to show only one steward queue, the request could in some instances be routed to multiple stewards, in series or in parallel.

If the change is acceptable to the steward queue 220, the update request is routed to a backend processing queue 230. The backend processing queue 230 may be an automated process with the authority to commit the changes stored in the temporary data repository 195 to the enterprise asset data store 190. Depending on the configuration of the enterprise asset data store, activities performed by the backend processing queue 230 for updating the enterprise asset data store with the changes may include replicating the data to multiple operational and analytical data stores.

FIG. 3 shows an example process flow for ensuring the integrity of enterprise asset management data. Processing initiates with the receipt of an update request for a change to one or more enterprise asset management data elements (350). As noted, enterprise asset management entities include an equipment entity type, a functional location entity type, an MRO bill of material entity type, a catalog entity type, a maintenance item entity type, a maintenance plan entity type, a measuring points entity type, a production resource/tool entity type, a task list entity type, and a work center entity type. Changes to data elements can include modification to attributes of one or more entity, deletion of one or more entity, or addition of one or more entity.

As described in FIG. 2 and the associated description, the update request is received from a work queue having a requester role. As noted, a requester role has the security attributes to request a change to enterprise asset management data, but not to approve and enact the change. The change is stored in a temporary data repository that may record requested changes while they are being approved and modified. The temporary data repository may contain, for example, a copy of the changed data entities, or a transaction log of the underlying instructions to enact the changes.

An update request contains one or more changes to one or more enterprise asset management data elements. A data element can include a modification to one, or more than one, of the attributes of an entity. For example, the model number of a pump installed in a factory may need to be changed. A data element, in this example, is the value of the model number attribute for that pump, stored in the equipment entity data store. The data elements of an update request can also be attribute changes for more than one entity, including for more than one entity type. The data elements of the update request can also include directives for removal of entities of one or more entity type, and/or the addition of entities of one or more entity type.

The update request is now routed to one or more specialist work queue (355). Each specialist work queue may be assigned a specialist security role identifying the specific individuals who may access a specialist queue. In some cases, the update request may be routed to more than one specialist work queue. The routing may occur in series or in parallel. Multiple different specialist work queues may be responsible for reviewing and approving the changes to different data elements, or may serve as an additional check on the same data.

A workflow pattern may be specially designed using a workflow designer interface to customize the workflow for a given installation of systems and techniques at a particular site. The location of update requests in an overall workflow, the design of a workflow, and other information about a workflow may be stored in a workflow data/metadata store stored on one or more computer readable media of the system.

Each specialist work queue also has an associated first set of update validation rules for validating the update request. Update validation rules are associated with the entity type, as noted with respect to FIGS. 1 (142, 152, 162, 172, and 182, for example). The set of operative update validation rules may pertain to the data itself, or to the permissions a particular specialist possesses to modify specific data elements. In some cases, a message indicating the details of one or more of the violated update validation rules may be shown in a user interface for managing the queue.

If the request does not conform with all of the first set of update validation rules (360), the update request may be modified or returned to the requester queue for further processing (365). In some cases, a prompt may be rendered that displays information related to the rule violation and/or suggestions for remediation. If the update request conforms with all of the first set of update validation rules, processing continues on the “YES” branch and the update request is routed to one or more steward work queue (370).

The update request is received by one or more steward work queue (375). Each steward work queue may be assigned a steward security role identifying the specific individuals who may access a steward queue. In some cases, the update request may be routed to more than one steward work queue. The routing may occur in series or in parallel. Multiple different steward work queues may be responsible for reviewing and approving the changes to different data elements, or may serve as an additional check on the same data.

Each steward work queue also has an associated second set of update validation rules for validating the update request. Update validation rules are associated with the entity type, as noted with respect to FIG. 1 (142, 147, 152, 157, 162, 167, 172, 177, 182, 187). The update validation rules may pertain to the data itself, or to the permissions a particular steward possesses to modify specific data elements. In some cases, a message indicating the details of one or more of the violated update validation rules may be shown in a user interface for managing the queue. If the request does not conform with all of the second set of update validation rules (380), the update request may be returned to a prior work queue for further processing (385). A prior queue can include any of the one or more specialist work queues or the requester work queue. If the update request conforms with all of the second set of update validation rules, processing continues on the “YES” branch and the update request is routed to one or more backend work processing queue (390).

The update request is received at the backend processing work queue (395). The backend processing work queue may be an automated process. The backend processing work queue may be assigned a backend processing authorization role possessing the authority to commit the changes stored in the temporary data repository 195 to the enterprise asset data store 190. Depending on the configuration of the enterprise asset data store, activities performed by the backend processing work queue for updating the enterprise asset data store with the changes may include replicating the data to multiple operational and analytical data stores.

It is noted that the validations depicted at blocks 360 and 380 may not require operator intervention in some instances. In particular, it may be possible under certain circumstance to confirm that a request complies with certain rules or rule sets simply by parsing data objects associated with the request and comparing those data objects with rules or other criteria attendant to the particular work queue validation procedure.

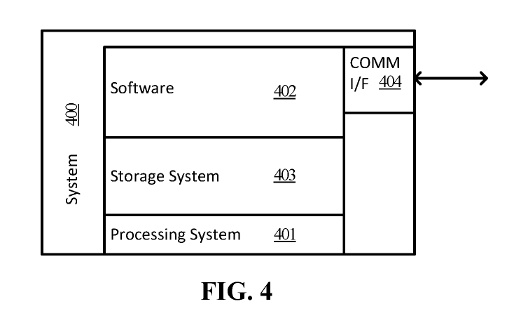

FIG. 4 shows a block diagram illustrating components of a computing device or system used in some implementations. For example, any computing device operative to run an application having a requester work queue 100, specialist work queue 110, steward work queue 120, backend processing work queue 130, enterprise asset management data store 190, or temporary repository 195 (from FIG. 1), or intermediate devices facilitating interaction between other devices in the environment, may each be implemented as described with respect to system 400, which can itself include one or more computing devices. The system 400 can include one or more blade server devices, standalone server devices, personal computers, routers, hubs, switches, bridges, firewall devices, intrusion detection devices, mainframe computers, network-attached storage devices, and other types of computing devices or data processing hardware components. The server hardware can be configured according to any suitable computer architectures such as a Symmetric Multi-Processing (SMP) architecture or a Non-Uniform Memory Access (NUMA) architecture.

The system 400 can include a processing system 401, which may include a processing device such as a central processing unit (CPU) or microprocessor and other circuitry that retrieves and executes software 402 from storage system 403. Processing system 401 may be implemented within a single processing device but may also be distributed across multiple processing devices or sub-systems that cooperate in executing program instructions.

Examples of processing system 401 include general purpose central processing units, application specific processors, and logic devices, as well as any other type of processing devices, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 403 may comprise any computer readable storage media readable by processing system 401 and capable of storing software 402 or other computer readable and computer executable instruction sets. Storage system 403 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic storage (e.g., disks, tapes, devices), optical storage (e.g., disks, devices), CDs, DVDs, flash memory, phase change memory, or any other suitable storage media. Certain implementations may involve either or both virtual memory and non-virtual memory. In addition to storage media, in some implementations storage system 403 may also include communication media over which software 402 may be communicated internally or externally.

Storage system 403 may be implemented as a single storage device but may also be implemented across multiple storage devices or sub-systems co-located or distributed relative to each other. Storage system 403 may include additional elements, such as a controller, capable of communicating with processing system 401.

Software 402 may be implemented in program instructions and among other functions may, when executed by system 400 in general or processing system 401 in particular, direct system 400 or processing system 401 to operate as described herein for ensuring the integrity of enterprise asset management data. Software 402 may provide program instructions that implement queue application, enterprise asset management data store, temporary repository, and workflow roles and management component. Software 402 may implement on system 400 components, programs, agents, or layers that implement in computer or machine-readable processing instructions the methods described herein for ensuring the integrity of enterprise asset management data.

Software 402 may also include additional processes, programs, or components, such as operating system software or other application software. Software 402 may also include firmware or some other form of machine-readable processing instructions executable by processing system 401.

In general, software 402 may, when loaded into processing system 401 and executed, transform system 400 overall from a general-purpose computing system into a special-purpose computing system customized to ensure the integrity of enterprise asset management data. Indeed, encoding software 402 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-readable storage media are characterized as primary or secondary storage.

System 400 may represent any computing system on which software 402 may be staged and from where software 402 may be distributed, transported, downloaded, or otherwise provided to yet another computing system for deployment and execution, or yet additional distribution.

It should be noted that many elements of system 400 may be included in a system-on-a-chip (SoC) device. These elements may include, but are not limited to, the processing system 401, a communications interface 404, and even elements of the storage system 403 and software 402.

In embodiments where the system 400 includes multiple computing devices, one or more communications networks may be used to facilitate communication among the computing devices. For example, the one or more communications networks can include a local, wide area, or ad hoc network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 404 may be included, providing communication connections and devices that allow for communication between system 400 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. The aforementioned communication media, network, connections, and devices are well known and need not be discussed at length here.

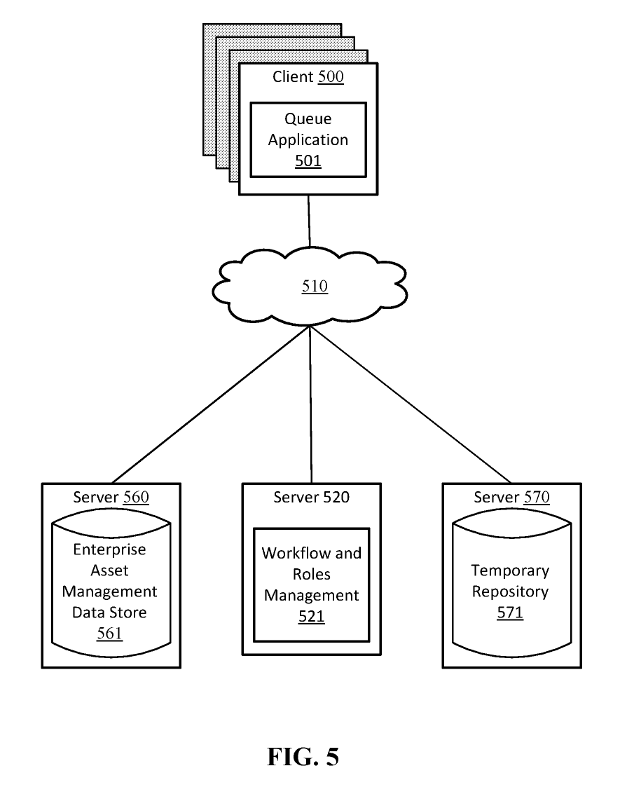

FIG. 5 illustrates an example system architecture in which an implementation of techniques and systems for ensuring the integrity of enterprise asset management data may be carried out. In the example illustrated in FIG. 5, a queue application 501 can be implemented on a client device 500, which may be a particular instantiation of a system 400 as described with respect to FIG. 4, and may be or include computing systems such as a laptop, desktop, tablet, mobile phone, and the like. Many queue applications may be present in a given environment (represented by the gray shadow boxes behind 500). Each queue application 501 may represent a work queue or instance of a work queue.

Communications and interchanges of data between components in the environment may take place over network 510. The network 510 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

A workflow and roles management component 521, appropriate for routing update requests between queues, designing workflows between work queues, and managing data with respect to workflow activities, may be implemented as software or hardware (or a combination thereof) on server 520, which also may be an instantiation of system 400. It is noted that a pure software implementation of component 521 will be supported by data processing elements or other hardware components resident on or accessible by server 520.

Enterprise asset management data store 561, which stores enterprise asset management entity types and entities, may be implemented as software or hardware (or a combination thereof) on server 560, which also may be an instantiation of system 400. Enterprise asset management data store may be implemented, for example, as a relational database or tables and objects thereof. A relational database maybe implemented on a relational database management system, such as SAP® or Microsoft SQL Server®.

Temporary repository 571, which stores enterprise asset management data element changes temporarily during the update request workflow processing, may be implemented as software or hardware (or a combination thereof) on server 570, which also may be an instantiation of system 400. Temporary repository 571 may be a separate component from the enterprise asset management data store 561, or may be hosted by same.

FIG. 5 shows system components operative on separate devices 500, 520, 560, and 570. It should be noted, however, that any number of and even all of the software components described above as queue application 501, workflow and roles management 521, enterprise asset management data store 561, and temporary repository 571 need not be run on separate devices, and may indeed be run on the same device.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain aspects of the invention provide the following non-limiting embodiments:

### Example 1

A system for ensuring the integrity of enterprise asset management data, the system comprising: one or more computer readable storage media; at least one enterprise asset management data store contained on at least one of the one or more computer readable storage media, the at least one enterprise asset management data store comprising one or more enterprise asset management data entities of an entity type selected from the group consisting of an equipment entity type, a functional location entity type, an MRO bill of material entity type, a work center entity type, a catalog entity type, a maintenance item entity type, a maintenance plan entity type, a measuring points entity type, a production resource/tool entity type, and a task list entity type; program instructions stored on the one or more computer readable storage media that, when executed by a processing system, direct the processing system to: receive, from a requester work queue having a requester role, an update request for a change to a particular one or more enterprise asset data elements, wherein the change to the particular one or more enterprise asset data elements is stored in a temporary data repository; route the update request to one or more specialist work queue, each specialist work queue having a specialist role and a first set of update validation rules for validating the update request, and when the update request violates a subset of the first set of update validation rules, modify the update request or return the update request to the requester work queue, and when the update request conforms with all of the first set of update validation rules, route the update request to one or more steward work queue; receive the update request at the one or more steward work queue, each steward work queue having a steward role and a second set of update validation rules for validating the update request, and when the update request violates a subset of the second set of update validation rules, return the update request to a prior work queue, and when the update request conforms with all of the second set of update validation rules, route the update request to a backend processing work queue; and receive the update request at the backend processing work queue, the backend processing work queue having a backend processing authorization role, and update the at least one enterprise asset management data store with the change to the particular one or more enterprise asset data elements stored in the temporary data repository.

### Example 2

The system of example 1, wherein a particular enterprise asset data entity of the equipment entity type comprises data describing a single physical object that is maintained as an autonomous unit.

### Example 3

The system of any of examples 1-2, wherein a particular enterprise asset data entity of the functional location entity type comprises data describing a place at which a maintenance task is performed, wherein the place is described according to functional, process-oriented, or spatial criteria.

### Example 4

The system of any of examples 1-3, wherein a particular enterprise asset data entity of the MRO bill of material entity type comprises data describing a quantity, a unit of measure, and a description of one or more components that make up a physical object.

### Example 5

The system of any of examples 1-4, wherein a particular enterprise asset data entity of the work center entity type comprises data describing where and when an activity is performed.

### Example 6

The system of any of examples 1-5, wherein the first set of update validation rules and the second set of update validation rules are comprised of rules associated with one or more of the entity types.

### Example 7

The system of any of examples 1-6, wherein the update request for the change to the particular one or more enterprise asset management data elements comprises one or more of: adding a new entity, modifying an attribute of an existing entity, and deleting a particular entity.

### Example 8

The system of any of examples 1-7, wherein the routing to a plurality of specialist work queues is performed in series or in parallel.

### Example 9

The system of any of examples 1-8, wherein the routing to a plurality of steward work queues is performed in series or in parallel.

### Example 10

The system of any of examples 1-9, further comprising program instructions stored on the one or more computer readable storage media that, when executed by the processing system: render an interface for defining a unique work queue routing workflow; and store the unique work queue routing workflow on the at least one enterprise asset management data store.

### Example 11

A method for ensuring the integrity of enterprise asset management data within a data store, the method comprising: receiving, from a requester work queue having a requester role, an update request for a change to a particular one or more enterprise asset data elements of one or more enterprise asset management data entities stored on the data store, wherein the change to the particular one or more enterprise asset data elements is stored in a temporary data repository, wherein the one or more enterprise asset management data entities have an entity type selected from the group consisting of an equipment entity type, a functional location entity type, an MRO bill of material entity type, a work center entity type, a catalog entity type, a maintenance item entity type, a maintenance plan entity type, a measuring points entity type, a production resource/tool entity type, and a task list entity type; routing the update request to one or more specialist work queue, each specialist work queue having a specialist role and a first set of update validation rules for validating the update request, and when the update request violates a subset of the first set of update validation rules, modifying the update request or returning the update request to the requester work queue, and when the update request conforms with all of the first set of update validation rules, routing the update request to one or more steward work queue; receiving the update request at the one or more steward work queue, each steward work queue having a steward role and a second set of update validation rules for validating the update request, and when the update request violates a subset of the second set of update validation rules, returning the update request to a prior work queue, and when the update request conforms with all of the second set of update validation rules, routing the update request to a backend processing work queue; and receiving the update request at the backend processing work queue, the backend processing work queue having a backend processing authorization role, and updating the data store with the change to the particular one or more enterprise asset data elements stored in the temporary data repository.

### Example 12

The method of example 11, wherein a particular enterprise asset data entity of the equipment entity type comprises data describing a single physical object that is maintained as an autonomous unit.

### Example 13

The method of any of examples 11-12, wherein a particular enterprise asset data entity of the functional location entity type comprises data describing a place at which a maintenance task is performed, wherein the place is described according to functional, process-oriented, or spatial criteria.

### Example 14

The method of any of examples 11-13, wherein a particular enterprise asset data entity of the MRO bill of material entity type comprises data describing a quantity, a unit of measure, and a description of one or more components that make up a physical object.

### Example 15

The method of any of examples 11-14, wherein a particular enterprise asset data entity of the work center entity type comprises data describing where and when an activity is performed.

### Example 16

The method of any of examples 11-15, wherein the first set of update validation rules and the second set of update validation rules are comprised of rules associated with one or more of the entity types.

### Example 17

The method of any of examples 11-16, wherein the update request for the change to the particular one or more enterprise asset management data elements comprises one or more of: adding a new entity, modifying an attribute of an existing entity, and deleting a particular entity.

### Example 18

The method of any of examples 11-17, wherein the routing to a plurality of specialist work queues is performed in series or in parallel.

### Example 19

The method of any of examples 11-18, wherein the routing to a plurality of steward work queues is performed in series or in parallel.

### Example 20

The method of any of examples 11-19, further comprising: rendering an interface for defining a unique work queue routing workflow; and storing the unique work queue routing workflow on the data store.

### Example 21

One or more computer readable storage media having instructions stored thereon, that when executed by a processing system, direct the processing system to perform the method according to any of examples 1-20.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

TABLE 1A
Equipment Entity

| Attribute | Description |
|---|---|
| EQUI | Equipment Number |
| ABCK_EILO | ABC indicator for technical object |
| ANL2_EILO | Asset Subnumber |
| ANL1_EILO | Main Asset Number |
| AUFN_EILO | Settlement order |
| BEBE_EILO | Plant section |
| BUKR_EILO | Company Code |
| DATBI_EIL | Valid To Date |
| DAUF_EILO | Standing order number |
| GSBE_EILO | Business Area |
| INGR_EEQZ | Planner Group for Customer Service |
| | and Plant Maintenance |
| KOKR_EILO | Controlling Area |
| KOST_EILO | Cost Center |
| LAGER_EQI | Storage Location |
| EQASP | Language Key (Technical) |
| MAT_EQU | Material Number |
| OBJI_EEQZ | Object ID of the resource |
| OBJI_EILO | Object ID of the resource |
| OBJT_EQUI | Object types of the CIM resource |
| PPLA_EEQZ | Maintenance Planning Plant |
| PROI_EILO | Work Breakdown Structure Element (WBS Element) |
| RBNR_EEQZ | Catalog Profile |
| STOR_EILO | Location of maintenance object |
| SUBM_EEQZ | Material Number |
| SWER_EILO | Maintenance plant |
| TPLN_EILO | Functional Location |
| WERK_EQUI | Plant |
| ANSDT | Acquisition date |
| ANSWT | Acquisition Value |
| ARBP_EEQZ | Main Work Center |
| ARBP_EILO | Main Work Center |
| BAUJJ | Year of construction |
| BAUMM_EQI | Month of construction |
| BEGRU | Technical object authorization group |
| BRGEW | Gross Weight |
| CONSTY_TX | Material Description (Short Text) |
| CR_KTEXT | Work Center text |
| DATA_EEQZ | Valid-From Date |
| DATB_EEQZ | Valid To Date |
| EEQZ_TEXT | Main Work Center description |
| EQART_EQU | Technical Object Type |
| EQFN_EILO | Sort field |
| EQTYP | Equipment category |
| FING | Person Responsible for Company Area |
| GERNR | Serial Number |
| GEWEI | Unit of weight |
| GROES_EQU | Size/dimension |
| HEQN_EEQZ | Equipment position at InstallLoc |
| | (Superior Equip./FunctLoc) |
| HEQU_EEQZ | Superordinate Equipment |
| HERLD | Country of manufacture |
| HERST | Manufacturer Name |
| INBDT | Start-up Date of the Technical Object |
| INVNR | Inventory number |
| I_TEXT | Description of the Planner Group |
| KMATN | Configurable Material |
| KOST_TEXT | Cost Center description |
| KRFKZ | Referenced Configuration |
| KTEXT | Location text |
| LSERNR | Last Numerical Serial Number |
| LVORM_EQI | Flag Equipment for Deletion at Client Level |
| MAPA_EEQZ | Manufacturer part number |
| MSGR_EILO | Room |
| PS_PSP_PN | Work Breakdown Structure Element (Stock Segm) |
| REFEQ | Reference Equipment |
| SERGE | Manufacturer serial number |
| SERNR | Serial Number |
| SMAT_TEXT | Serialization Material description (short text) |
| STATTEXT | System Status text |
| TELE | Phone number of person responsible for company area |
| TIDN_EEQZ | Technical identification number |
| TXT50 | Asset description |
| TYPBZ | Manufacturer model number |
| WAERS | Currency Key |
| WERGW_EQI | Plant associated with main work center |
| CLASS | Class number |
| CLSS_EQCL | Class Type |
| CLSTAEQCL | Status for Class Assignment Entry |
| STDLC | Standard Class Indicator |
| ZAEHL | Sort Item |
| MGANR | Master Warranty (Warranty attributes) |
| OBJNR | Object number (Warranty attributes) |
| GAART | Warranty type (Warranty attributes) |
| GWLDT | Begin Guarantee (Warranty attributes) |
| GWLEN | Warranty End (Warranty attributes) |
| WAGET | Inherit Warranty (Warranty attributes) |
| GAERB | Pass on Warranty (Warranty attributes) |
| KUNNR | Customer Account Number |
| LANGUCODE | Language Code |

TABLE 1B
Equipment Entity Business Rules

| Rule Control | | Comment |
|---|---|---|
| Number | Business Rule Description | (Message Displayed) |
| EAM-EQUI-001 | Equipment Category is a | Enter required |
| | required field. | field equipment |
| | | category. |
| EAM-EQUI-002 | Default Valid To Date to | No message displayed |
| | 31.12.9999. | |
| EAM-EQUI-003 | Default Valid From Date to | No message displayed |
| | current date. | |
| EAM-EQUI-004 | Valid From Date can't be a | Valid-from date |
| | future date | is in the future. |
| EAM-EQUI-005 | Company Code should be | No message displayed |
| | automatically derived when the | |
| | Maintenance Plant is | |
| | populated. | |
| EAM-EQUI-006 | Controlling Area should be | No message displayed |
| | read-only and automatically | |
| | derived when the Maintenance | |
| | Plant or Company Code is | |
| | populated. If Company Code or | |
| | Maintenance Plant is blanked | |
| | out, Controlling Area should | |
| | also get blanked out. | |
| EAM-EQUI-007 | Planning Plant should be | No message displayed |
| | automatically derived when the | |
| | Maintenance Plant is | |
| | populated. | |
| EAM-EQUI-008 | Work Center can't exist without | Please enter |
| | Maintenance Plant. | required field |
| | | Maintenance plant |
| EAM-EQUI-009 | Work Center must exist in the | Work center |
| | Maintenance Plant. | (ARBP_EILO) does |
| | | not exist in plant |
| | | (SWER_EILO) |
| EAM-EQUI-010 | If both Functional Location and | Enter correct |
| | Superordinate Equipment are | installed function |
| | entered, validate that the | location. |
| | Superordinate Equipment is | |
| | installed at the Functional | |
| | Location | |
| EAM-EQUI-011 | Superordinate Equipment must | Different plants not |
| | be maintained at same plant as | permitted within an |
| | Equipment | equipment hierarchy |
| EAM-EQUI-012 | Functional Location must be at | Different plants |
| | same plant as Equipment | not permitted for |
| | | installation/dismantling |
| EAM-EQUI-013 | If both Functional Location and | No message displayed |
| | Superordinate Equipment are | |
| | entered, change the Functional | |
| | Location to one Superordinate | |
| | Equipment is installed at if | |
| | different. | |
| EAM-EQUI-014 | Validate external Equipment | Equipment number |
| | Number against external | (EQUI) not in external |
| | number interval. Validate if | number interval |
| | external numbering allowed. | Field Contains Invalid |
| | Check for invalid characters. | Characters, please |
| | | Check the Equipment |
| | | Number No internal |
| | | number range |
| | | defined for equipment |
| | | category |
| EAM-EQUI-015 | Main Work Center Plant can't | Please enter |
| | be entered without entering | required field |
| | Main Work Center. | main work center |
| EAM-EQUI-016 | Serial Number can't exist | Enter required field |
| | without Material Number. | material number |
| | | corresponding to serial |
| | | number (SERNR) |
| EAM-EQUI-017 | Serial Number must be unique | Serial number |
| | within Material Number. | (SERNR) already |
| | | exists for material |
| | | (MAT_EQU) |
| EAM-EQUI-018 | Configurable Material must be | Material (KMATN) |
| | defined as configurable. | is not a configurable |
| | | material |
| EAM-EQUI-019 | Main Work Center Plant must | MaintPlant |
| | exist in the same Controlling | (SWER_EILO) and |
| | Area as Maintenance Plant. | WorkCtr plant |
| | | (WERGW_EQI) |
| | | are in different |
| | | CtrIngAreas |
| EAM-EQUI-020 | If Main Work Center manually | No message displayed |
| | entered and Main Work Center | |
| | Plant not entered, take Main | |
| | Work Center Plant from | |
| | Planning Plant. | |
| EAM-EQUI-021 | If Acquisition Value entered, | Maintain the |
| | Unit of Currency must be | currency for the |
| | entered. | acquisition value |
| EAM-EQUI-022 | Planning Plant and | MaintPlant |
| | Maintenance Plant must be in | (SWER_EILO) and |
| | the same Controlling Area | PlanPlant |
| | | (PPLA_EEQZ) are in |
| | | different controlling |
| | | areas |
| EAM-EQUI-023 | If Superordinate Equipment is | No message displayed |
| | installed at a Functional | |
| | Location, derive that Functional | |
| | Location. | |
| EAM-EQUI-024 | If Material Number is entered, | No message displayed |
| | derive the last serial number | |
| | used. | |
| EAM-EQUI-025 | If Main Work Center manually | Enter the plant |
| | entered and Planning Plant not | for the main |
| | entered, Main Work Center | work center |
| | Plant must be manually | |
| | entered. | |
| EAM-EQUI-026 | Can't enter a Class not | Class (CLASS) |
| | belonging to an Equipment | not yet created |
| | Class Type | |
| EAM-EQUI-027 | Only one Class can be selected | Only one class |
| | as the Standard Class | can be selected |
| | | as a standard class |
| EAM-EQUI-028 | Check if Equipment Category | |
| | allows installation at a | |
| | Functional Location. | |

TABLE 2A
Functional Location Entity

| Attribute | Description |
|---|---|
| FUNCLOC | Functional Location |
| ABCKZFLOC | ABC indicator for technical object |
| ANLA_FL | Asset Subnumber |
| ANLN1_FL | Main Asset Number |
| ARBPLFLOC | Work center |
| AUFN_FLOC | Settlement order |
| BEBER_FL | Plant section |
| BUKRSFLOC | Company Code |
| DATBI_FLO | Valid To Date |
| DAUF_FLOC | Standing order number |
| EDIT_FLOC | Functional location edit mask |
| GEWRKFLOC | Main work center for maintenance tasks |
| GSBE_FLOC | Business Area |
| INGR_FLOC | Planner Group for Customer Service |
| | and Plant Maintenance |
| JOBJN_FL | Object number |
| KOKR_FLOC | Controlling Area |
| KOST_FLOC | Cost Center |
| OBJIDFLOC | Object ID of the resource |
| OBJTYFLOC | Object types of the CIM resource |
| PAVW_FLOC | Partner Function |
| PLNT_FLOC | Maintenance Planning Plant |
| PROI_FLOC | Work Breakdown Structure Element (WBS Element) |
| RBNR_FLOC | Catalog Profile |
| STOR_FLOC | Location of maintenance object |
| STUF_FLOC | Functional Location Hierarchy Levels |
| SUBMTIFLO | Material Number |
| SWERK_FL | Maintenance plant |
| TPLKZ_FLC | Functional location structure indicator |
| ANSDT | Acquisition date |
| ANSWT | Acquisition Value |
| BAUJJ | Year of construction |
| BAUMM | Month of construction |
| BEGRU | Technical object authorization group |
| BRGEW | Gross Weight |
| CONSTY_TX | Material Description (Short Text) |
| CR_KTEXT | Short description |
| EINZL | Single equipment installation at functional location |
| EQART | Type of Technical Object |
| EQFNR | Sort field |
| FING | Person Responsible for Company Area |
| FLTYP | Functional location category |
| GEWEI | Unit of weight |
| GROES | Size/dimensions |
| HERLD | Country of manufacture |
| HERST | Manufacturer of asset |
| IEQUI | Installation of equipment allowed |
| | at the functional location |
| IFLOT_SRT | Shift Report Type for Object |
| INBDT | First start-up date |
| INVNR | Inventory number |
| I_TEXT | Description of the Planner Group |
| KOST_TEXT | General Name |
| KTEXT | Text, 40 Characters Long |
| LVORM | Flag for Deletion |
| MAPAR | Manufacturer part number |
| MSGRP | Room |
| MWRKCT_TX | Object Name |
| ORT01 | City |
| POSNR | Position in superior technical object |
| SERGE | Manufacturer serial number |
| STATTEXT | Display lines for system status |
| STTXU | Display lines for user status |
| TELE | Phone number of person responsible for company area |
| TPLCP | Functional location as copy reference |
| TPLMA | Superior functional location |
| TPLMA1 | Superior functional location |
| TRPNR; | Reference functional location |
| TRPNR1 | Reference functional location |
| TXT50 | Asset description |
| TYPBZ | Manufacturer model number |
| WAERS | Currency Key |
| WERGWFLOC | Plant associated with main work center |
| LANGUCODE | Language Key |
| KZMLA | Primary language indicator for text segment |
| PLTXT | Description of functional location |
| EQUI | Equipment Core Data |
| FUNCLOC | Functional Location (Warranty attributes) |
| MGANR | Master Warranty (Warranty attributes) |
| OBJNR | Object number (Warranty attributes) |
| GAART | Warranty type (Warranty attributes) |
| GWLDT | Begin Guarantee (Warranty attributes) |
| GWLEN | Warranty End (Warranty attributes) |
| WAGET | Inherit Warranty (Warranty attributes) |
| GAERB | Pass on Warranty (Warranty attributes) |
| FUNCLOC | Functional Location (Functional Location attributes) |
| LANGUCODE | Language Key (Functional Location attributes) |
| KZMLA | Primary language indicator for text segment |
| | (Functional Location attributes) |
| PLTXT | Description of functional location |
| | (Functional Location attributes) |

TABLE 2B
Functional Location Business Rules

| Rule Control | Business Rule | Comment (Message |
|---|---|---|
| Number | Description | Displayed) |
| EAM-FLOC-001 | If Acquisition Value | Maintain the currency |
| | entered, Unit of | for the acquisition |
| | Currency must be | value |
| | entered. | |
| EAM-FLOC-002 | Planner Group can't | Planning plant does not |
| | exist without a Planning | support MaintPlanGrp |
| | Plant. | (INGR_FLOC) |
| EAM-FLOC-003 | Location can't exist | Plant does not |
| | without a Maintenance | support location |
| | Plant. | (STOR_FLOC) |
| EAM-FLOC-004 | Work Center can't exist | Enter the plant for the |
| | without a Maintenance | main work center |
| | Plant. | |
| EAM-FLOC-005 | Work Center must exist | Work center (ARBPLFLOC) |
| | in the Maintenance | does not exist in |
| | Plant. | plant (SWERK_FL) |
| EAM-FLOC-006 | Plant Section can't exist | Maintenance plant does |
| | without a Maintenance | not support plant |
| | Plant. | section (BEBER_FL) |
| EAM-FLOC-007 | Structure Indicator is a | Functional Loc. |
| | required field. | (FUNCLOC): Enter a value |
| | | for attribute StrIndicator |
| EAM-FLOC-008 | Functional Location | Functional Loc. |
| | Category is a required | (FUNCLOC): Enter a value |
| | field. | for attribute FunctLocCat |
| | | Category not defined for |
| | | functional locations |
| EAM-FLOC-009 | Functional Location does | Functional location |
| | not support internal | does not support |
| | numbering. | internal number handling |
| EAM-FLOC-010 | Main Work Center Plant | No message displayed |
| | can't be entered without | |
| | entering Main Work | |
| | Center. | |
| EAM-FLOC-011 | If Main Work Center | Planning plant is taken |
| | manually entered and | as the plant for the |
| | Main Work Center Plant | main work center |
| | not entered, take Main | |
| | Work Center Plant from | |
| | Planning Plant. | |
| EAM-FLOC-012 | Main Work Center Plant | MaintPlant (SWERK_FL) |
| | must exist in the same | and WorkCtr plant |
| | Controlling Area as | (WERGWFLOC) are in |
| | Maintenance Plant. | different CtrIngAreas |
| EAM-FLOC-013 | Planning Plant should be | No message displayed |
| | automatically derived | |
| | when the Maintenance | |
| | Plant is populated. | |
| EAM-FLOC-014 | Company Code should | No message displayed |
| | be automatically derived | |
| | when the Maintenance | |
| | Plant is populated. | |
| EAM-FLOC-015 | Controlling Area should | No message displayed |
| | be read-only and | |
| | automatically derived | |
| | when the Maintenance | |
| | Plant or Company Code | |
| | is populated. If Company | |
| | Code or Maintenance | |
| | Plant is blanked out, | |
| | Controlling Area should | |
| | also get blanked out. | |
| EAM-FLOC-016 | Planning Plant and | MaintPlant (SWERK_FL) |
| | Maintenance Plant must | and PlanPlant (PLNT_FLOC) |
| | be in the same | are in different controlling |
| | Controlling Area | areas |
| EAM-FLOC-017 | If Main Work Center | Enter the plant for the |
| | manually entered and | main work center |
| | Planning Plant not | |
| | entered, Main Work | |
| | Center Plant must be | |
| | manually entered. | |

TABLE 3A
MRO Bill of Materials (BOM) Entity

| Attribute | Description |
|---|---|
| MATNR/EQUNR/TPLNR | Material |
| STALT | Alternative BOM |
| STLAN | BOM Usage |
| WERKS | Plant |
| PMBOMGRP | BOM group |
| PMBOMTECH | Technical type |
| ALEIND | ALE Indicator |
| AUTHGROUP | Authorization Group |
| BASEQTY | Base Quantity |
| BASEUOM | Base Unit Of Measure |
| BOMSTATUS | BOM Status |
| CADIND | CAD Indicator |
| DELFLG | Deletion Flag |
| DELIND | Deletion Indicator |
| DVALIDFRM | Valid-From Date |
| LABOFC | Lab Office |
| LNGTXT | BOM Long Text |
| SIZDIM | Size Dimension |
| STKTX | Alternate Text |
| STNUM | Bill of Material |
| VALIDFROM | Valid From Date |
| VALIDTODA | Valid To Date |

TABLE 3B
MRO Bill of Materials Components

| Attribute | Description |
|---|---|
| MATNR | Material Number |
| STALT | Alternative BOM |
| STLAN | BOM Usage |
| WERKS | Plant |
| BOMITMPOS | BOM Item Number |
| BOMDOCITM | Document number |
| BOMITMCLS | Class Type |
| BOMITMDKR | Document Type |
| BOMITMDTL | Document Part |
| BOMITMDVR | Document Version |
| ITMCATREF | Item Category (Bill of Material) |
| ITMCOMP | BOM component |
| ITM_KTOPL | Chart of Accounts |
| ITM_SAKTO | Cost Element |
| ITSOBBOM | Special procurement type for BOM item |
| VERTLBOM | Distribution key for component consumption |
| ASSELCND | Indicator: classification as selection condition |
| COMPDESC | Material Description (Short Text) |
| COMPNET | Indicator: Net scrap |
| COMPSCRAP | Component scrap in percent |
| COPROD | Indicator: co-product |
| COSTGRELV | Indicator for relevancy to costing |
| EKGRP | Purchasing Group |
| EKORG | Purchasing Organization |
| ERSKZ | Indicator: spare part |
| EXPLTYP | Explosion type |
| FIXEDQTY | Quantity is Fixed |
| ITEMID | Item ID |
| ITMASSIND | Indicator: assembly |
| ITMBULMAT | Indicator: Bulk Material |
| ITMLNGTXT | BOM Item Long Text |
| ITMOBJIND | Indicator: object dependencies exist |
| ITMQTY | Component quantity |
| ITMSUBIND | Indicator: sub-items exist |
| ITMUOM | Component unit of measure |
| LEADTIMEO | Lead-time offset |
| LGTXTIND | Indicator: long text exists for item |
| LIFZT | Delivery Time (days) |
| MATKL | Material Group |
| MATPROIND | Material Provision Indicator |
| OPERLTOFS | Lead-time offset for operation |
| OPERLTUNI | Unit for lead-time offset for operation |
| OPERSCRAP | Operation scrap |
| PEINH | Price Unit |
| PHANTOMIN | Phantom item indicator |
| PMASSMBLY | PM assembly indicator |
| POTX1 | BOM Item Text (Line 1) |
| POTX2 | BOM item text (line 2) |
| PREIS | Price |
| RECURALLO | Indicator: recursiveness allowed |
| SCHKZ | Bulk Material Indicator in Material Master |
| SORTSTRIN | Sort String |
| STLKN | BOM item node number |
| STPOZ | Internal counter |
| VALIDFRM | Valid-From Date |
| VALIDTO | Valid-to date |
| VENDOR | Vendor |
| WAERS | Currency |
| WEBAZ | GR Processing Time |
| BOMCLASTY | BOM Class Type |
| BOMGROUP | BOM Group |
| BOMITMCAT | BOM Item Category |
| BOMITMCOM | BOM Item Component |
| BOMITMPOS | BOM Item Number |
| BOMTECHTP | Technical Type |
| DOKAR | Document Type |
| DOKTL | Document Part |
| DOKVR | Document Version |
| DRAW | Document Number |
| ITSOB | Special Procurement |
| KTOPL | Chart of Accounts |
| MATNR | Material Number |
| SAKTO | Cost Element (MRO Bill of Materials Planner |
| | Group for Customer Service and Plant |
| | Maintenance) |
| STALT | Alternative BOM |
| STLAN | BOM Usage |
| VERTL | Distribution Key |
| WERKS | Plant |

TABLE 3C
MRO Bill of Material Business Rules

| | | Comment |
|---|---|---|
| | | (Message |
| Rule Control Number | Business Rule Description | Displayed) |
| EAM-MROBOM-001 | Derivation of Header | No Message |
| | Material description from table | |
| | MAKT-MAKTX | |
| EAM-MROBOM-002 | Base quantity field to be | No Message |
| | defaulted from table TCS03_ | |
| | V-BMENG | |
| EAM-MROBOM-003 | Header Material UOM to be | No Message |
| | defaulted from Material master | |
| | Base UOM, from table MARA- | |
| | MEINS | |
| EAM-MROBOM-004 | Valid from Date at header level | No Message |
| | to system date (current date) | |
| EAM-MROBOM-005 | Default valid to date to | No Message |
| | 12/31/9999 | |
| EAM-MROBOM-006 | Bom Header status from | No Message |
| | TCS03_V-STLST | |
| EAM-MROBOM-007 | Lab Office at header default | No Message |
| | from Material master table | |
| | MARA-LABOR | |
| EAM-MROBOM-008 | Size dimensions derive from | No Message |
| | Material master table MARA- | |
| | GROES | |
| EAM-MROBOM-009 | Derive Component description | No Message |
| | from item material master | |
| | table MAKT-MAKTX | |
| EAM-MROBOM-010 | Derive UOM from | No Message |
| | item material | |
| | master MARA-MEINS | |
| EAM-MROBOM-011 | Derive Valid from Date at | No Message |
| | item level to system date | |
| | (current date) | |
| EAM-MROBOM-012 | Default valid to date to | No Message |
| | 12/31/9999 | |
| EAM-MROBOM-013 | Derive from BOM Usage | No Message |
| | “4” configuration | |
| EAM-MROBOM-014 | Derive from BOM Usage | No Message |
| | “4” configuration from table | |
| | T416V-SANKA | |
| EAM-MROBOM-015 | Derive Phantom item | No Message |
| | from Special procurement key | |
| | table T460A-DUMPS and if | |
| | Explosion type entered then, | |
| | table T414-KZDUM. | |
| EAM-MROBOM-016 | When component is | Material XX |
| | entered at item level, check for | not maintained |
| | existence of component in | in plant |
| | same header plant exist. | XXXX |
| EAM-MROBOM-017 | If Operation Scrap % is initial, | Operation scrap |
| | then if Net Indicator is not set | can only be |
| | then throw error message. | maintained in |
| | | connection with |
| | | net indicator |
| EAM-MROBOM-018 | If Component material and | BOM is |
| | header material are the same | recursive |
| | and Recursive Allow is initial, | |
| | then throw the Error Message | |
| EAM-MROBOM-019 | Cannot have both | Bulk material |
| | Cost Relevant | not allowed |
| | and Bulk Material | for items |
| | indicator set. | relevant |
| | | to costing |
| EAM-MROBOM-020 | Only Alternative BOM ‘1’ is | No Message |
| | supported with the | |
| | standard APIs and IDoc | |
| | Messaging. Derive | |
| | default value of ‘1’ | |
| EAM-MROBOM-021 | Derive Bulk Material | No Message |
| | indicator from material master | |
| | for component items from | |
| | table MARC-SCHGT | |
| EAM-MROBOM-022 | Derive Phantom Item | No Message |
| | Indicator based on Explosion | |
| | Type/Special procurement key. | |
| EAM-MROBOM-023 | ITEM CATEGORY D | 1. Do not enter |
| | 1. Component cannot | material |
| | be entered | for item |
| | 2. Document, Document type, | category D. |
| | Document part, Doc version | Check item |
| | are mandatory | position xxxx |
| | 3. UOM Defaulted form table | 2. Please enter |
| | TCS03-BMEIN and | complete |
| | greyed out- | document key |
| | Known issue its editable now. | |
| | 4. Quantity defaulted to 1 | |
| | and editable | |
| | 5. Component description is | |
| | derived from Document | |
| | # description table DRAT- | |
| | DKTXT and greyed out | |
| | 6. Optional open fields | |
| | available for input: | |
| | Fixed qty and all other | |
| | fields greyed out. | |
| EAM-MROBOM-024 | ITEM CATEGORY T | 1. Do not enter |
| | 1.UOM Defaulted form table | material |
| | TCS03-BMEIN and editable | for item |
| | 2. Quantity defaulted to 1 and | category T. |
| | editable | Check item |
| | 3. Fixed quantity checkbox | position |
| | activated and editable | xxxx |
| | 4. item text mandatory | |
| EAM-MROBOM-025 | ITEM CATEGORY I | No Message |
| | 1. Component Mandatory | |
| | 2. UOM derived from | |
| | component and editable | |
| | 3. PM Assembly checkbox | |
| | activated and editable | |
| | 4. Optional fields available for | |
| | input: Recursive allowed, | |
| | explosion type, spl proc key, | |
| | spare parts indicator, costing | |
| | relevancy indicator | |
| EAM-MROBOM-026 | ITEM CATEGORY N-No | 1. Please |
| | Component | enter all |
| | 1.UOM Defaulted form | price data |
| | table TCS03-BMEIN | |
| | and editable | |
| | 2. Costing relevancy defaulted | |
| | from T416V-SANKA and | |
| | editable | |
| | 3. Currency defaulted to | |
| | company code assigned to | |
| | plant and editable | |
| | 4. Purchasing organization | |
| | derive from plant assigned to it | |
| | and editable | |
| | 5. Price unit defaulted to 1 and | |
| | editable | |
| | 6. Item text mandatory, item | |
| | price, purchasing | |
| | group, material | |
| | group mandatory fields | |
| | 7. Optional fields available for | |
| | input: fixed qty, operation scrap | |
| | in %, net id, component scrap, | |
| | recursive allowed, lead time | |
| | offset, OP It offset, distribution | |
| | key, explosion | |
| | type, spare part indicator, mat | |
| | provision indicator, Bulk | |
| | Material, vendor, cost element, | |
| | delivery time days, gr | |
| | processing time | |
| EAM-MROBOM-027 | ITEM CATEGORY N-With | 1. Please |
| | Component Material | enter all |
| | 1.UOM based on the based | price data |
| | unit of component and editable | |
| | 2. Costing relevancy defaulted | |
| | from T416V-SANKA and | |
| | editable | |
| | 3. Currency defaulted to | |
| | company code assigned to | |
| | plant and greyed out | |
| | 4. Derive Purch Group | |
| | from component master = | |
| | MARC-EKGRP and editable | |
| | 5. Derive Delivery Time from | |
| | component master = MARC- | |
| | PLIFZ − Derive if populated | |
| | and editable | |
| | 6. Material Grp | |
| | from component | |
| | master = MARA-MATKL − | |
| | Derive if populated | |
| | and editable | |
| | 7. GR Processing Time from | |
| | component master = MARC- | |
| | WEBAZ − Derive if | |
| | populated and editable | |
| | 8. Derive Price | |
| | from component | |
| | master = MBEW-VERPR if | |
| | MBEW-VPRSV = V (moving | |
| | average) or MBEW-STPRS if | |
| | MBEW-VPRSV = S (IF | |
| | standard) − Derive if | |
| | populated-greyed out | |
| | 9. Derive price unit from | |
| | component master = MBEW- | |
| | PEINH − Derive | |
| | if populated − Defaults | |
| | to 1 and greyed out | |
| | 10 Purchasing organization | |
| | derived from org assignment | |
| | and editable | |
| | 11. Optional fields | |
| | available for | |
| | input: Fixed qty, component | |
| | scrap, operation scrap, net id, | |
| | recursive allowed, Lead time | |
| | offset, Oper Lt offset, | |
| | Distribution key, Explosion | |
| | type, mat provision indicator, | |
| | Bulk Material, spare part | |
| | indicator, PM assembly, | |
| | vendor | |

TABLE 4A
Work Center Entity

| Attribute | Description |
|---|---|
| ARBPL | Work center |
| WERKS | Plant |
| CAPTEXT | Capacity short text |
| CPLGR | CAPP planner group |
| CRLOGRP | Wage group |
| CROBJID | Object ID of the resource |
| CROBJTY | Object types of the CIM resource |
| CRORTGR | Location group |
| CRPLNAW | Application of the task list |
| CRPRVBE | Production Supply Area |
| CRQUALF | Suitability |
| CRRASCH | Setup Type Key |
| CRSTAND | Work center location |
| CRSTEUS | Control key |
| CRVERAN | Person responsible for the work center |
| FORT1 | Formula for setup time |
| FORT2 | Formula for the duration of processing |
| | time |
| FORT3 | Formula for teardown time |
| FORTN | Formula for the duration of other type of |
| | int. processing |
| KAPAR | Capacity category |
| KTSCH | Standard text key |
| KTSCH_REF | Indicator: Standard text key is referenced |
| LNGTEXT | Work Center Long text |
| LOANZ | Number of Time Tickets |
| LOANZ_REF | Indicator: Number of time tickets is |
| | referenced |
| LOART | Wage Type |
| LOART_REF | Indicator: Wage type is referenced |
| LOGRP_REF | Indicator: Wage group is referenced |
| MATYP | Machine type |
| NAME | Capacity name |
| PDEST | Printer for shop papers |
| PLANV | Key for task list usage |
| QUALF_REF | Indicator: Suitability is referenced |
| RASCH_REF | Indicator: Setup type key is referenced |
| RGEKZ | Indicator: Backflushing |
| RSANZ | Number of confirmation slips |
| RSANZ_REF | Indicator: Number of confirmation slips is |
| | referenced |
| RUZUS | Key: rounding and additional values |
| SORTB | Sort string |
| STEUS_REF | Indicator: Control key is referenced |
| SUBSYS | Subsystem Identifier for QM Subsystem |
| | Interface |
| TXTMI | Description (medium text) |
| TXT_01 | Key word for parameter ID |
| TXT_02 | Key word for parameter ID |
| TXT_03 | Key word for parameter ID |
| TXT_04 | Key word for parameter ID |
| TXT_05 | Key word for parameter ID |
| TXT_06 | Key word for parameter ID |
| VERWE | Work Center Category |
| VGARB | Unit of measure of work |
| VGDIM | Dimension of work |
| VGE01 | Unit of measure for the standard value |
| VGE02 | Unit of measure for the standard value |
| VGE03 | Unit of measure for the standard value |
| VGE04 | Unit of measure for the standard value |
| VGE05 | Unit of measure for the standard value |
| VGE06 | Unit of measure for the standard value |
| VGM01 | Rule for standard value maintenance |
| VGM02 | Rule for standard value maintenance |
| VGM03 | Rule for standard value maintenance |
| VGM04 | Rule for standard value maintenance |
| VGM05 | Rule for standard value maintenance |
| VGM06 | Rule for standard value maintenance |
| VGWTS | Standard value key |
| ZEIWM | Unit for the minimum queue time |
| ZEIWN | Unit for the standard queue time |
| ZGR01 | ID |
| ZGR02 | ID |
| ZGR03 | ID |

TABLE 4B
Work Center Entity Business Rules

| Rule Control | Business Rule | Comment (Message |
|---|---|---|
| Number | Description | Displayed) |
| EAM-WRKCTR-001 | Validity start date- | Default to system Date and |
| | System start date | let the User change |
| EAM-WRKCTR-002 | Validity End Date- | Default to 12/31/9999 and |
| | 12/31/9999 | let the User change |
| EAM-WRKCTR-003 | Controlling Area | No Message Displayed |
| EAM-WRKCTR-004 | Standard Value Key | No Message Displayed |
| EAM-WRKCTR-005 | Capacity Planner | No Message Displayed |
| | Group | |
| EAM-WRKCTR-006 | Long Term Planning | No Message Displayed |
| EAM-WRKCTR-007 | Capacity Category | Capacities of Type1 and |
| | | Type 2 are only allowed |
| | | for resources. |
| EAM-WRKCTR-008 | Formulas | No Message displayed. |
| | | Values are derived only |
| | | in display mode. |
| EAM-WRKCTR-009 | Start | No Message displayed. |
| | | Value defaulted to |
| | | 00:00:00 |
| EAM-WRKCTR-010 | Finish | No Message displayed. |
| | | Value defaulted to |
| | | 00:00:00 |
| EAM-WRKCTR-011 | Length Of breaks | No Message displayed. |
| | | Value defaulted to |
| | | 00:00:00 |
| EAM-WRKCTR-012 | Pooled Capacity | No Message displayed. |
| EAM-WRKCTR-013 | Rule for maintenance | No Message displayed. |
| | field | |
| EAM-WRKCTR-014 | UOM of Capacity | No Message Displayed. |
| EAM-WRKCTR-015 | Operating Time & | No Message displayed |
| | Capacity | |
| EAM-WRKCTR-016 | Capacity Category | No Message displayed |
| EAM-WRKCTR-017 | Capacity | No Message displayed |
| EAM-WRKCTR-018 | Validity Start and | No Message displayed |
| | End date | |
| EAM-WRKCTR-019 | Machine type/ | “Machine type, capacity |
| | Sort string/ | planner group and sort |
| | Capp planner grp | string are mandatory”. |
| EAM-WRKCTR-020 | Capacity Allocations | No Message displayed |
| EAM-WRKCTR-021 | Cost Center | No Message displayed |
| | Assignments | |
| EAM-WRKCTR-022 | Pooled Capacity | No Message displayed |
| EAM-WRKCTR-023 | Pooled Capacity | No Message displayed |

TABLE 5A
Catalog Entity

| Attribute | Description |
|---|---|
| KATALOGART | Catalog |
| CODEGRUPPE | Code Group |
| KATALOGART | Catalog |
| KATALOGTXT | Catalog description |
| CODEGRUPPE | Code Group |
| KURZTEXT | Short text |
| STATUS | Status of code group |
| VERWENDUNG | Usage Indicator |
| ERSTELLER | Created by |
| E_DATUM | Created on |
| AENDERER | Chnaged by |
| A_DATUM | Changed on |
| CODE | Code |
| KURZTEXT | Short text for code |
| VERWENDUNG | Usage Indicator |
| ERSTELLER | Created by |
| E_DATUM | Created on |
| AENDERER | Chnaged by |
| A_DATUM | Changed on |
| KATALOGART | Catalog |
| CODEGRUPPE | Code Group |
| KLART | Class type |
| ARTXT | Class text |
| CLASS | Class |
| KLTXT | Class description |
| STDCL | Standard class |
| STATU | Status |
| ICON | Icon |
| ZAEHL | Itm |
| RBNR | Cat.Prof. |
| RBNRX | Catalog Profile |
| RBNR | Catalog Profile |
| RBNRX | Catalog Profile text |
| MSGTP | Message typ. During Insp. |
| FRKLS | Classification |
| FRKLSKZ | Class. Syatem screen |
| RBNR | Catalog Profile |
| RBNRX | Catalog Profile text |
| QKATART | Catalog |
| QCODEGRP | Code Group |

TABLE 6A
Measuring Points Entity

| Attribute | Description |
|---|---|
| MPOTY | MeasPointObject |
| EQUNR | Equipment |
| EQKTX | Description |
| MPTYP | MeasPtcategory |
| MPTTX | Description-Measuring point category |
| INDCT | Indicator: Measuring Point Is a Counter |
| POINT | Measuring point |
| MPTYP | Cat |
| MPTTX | Description-Category |
| PSORT | MeasPosition |
| PTTXT | Description |
| KZLTX | Indicator: Long text exists |
| MPOBK | Equipment |
| MPOBT | Description |
| ATNAM | Characteristic |
| UNITC | CharactUnit |
| INDCT | Indicator: Meas. Point counter |
| DECIM | Decimal Places |
| EXPON | FloatPointExp. |
| CODGR | Code group |
| CDSUF | ValCode sufficient |
| LOCAS | Assembly |
| BEGRU | AuthorizGroup |
| INDTR | MeasReadTransf. |
| TRANS | Transfer of |
| CJUMC | CntrOverReadg |
| MSEH6 | UOM of CntrOverReadg |
| INDRV | Count backwards |
| PYEAC | AnnualEstimate |
| ATEXT | Text |
| MRMAC | Upper range limit |
| MRMIC | Lower range limit |
| UNITM | MeasurmntRangeUnit |
| MSEHL | Description-UOM |
| INDTR | Indicator: Transfer supported |
| TRANS | Reading trans. Fr. |
| DATLO | Valid from |
| PSORT | Measurment position |
| PTTXT | Description |
| TXT20 | Text |
| MPOBT | Description |
| VALC1 | Entered value |
| UNIT1 | Unit of entry |
| MSEHL | Name of UOM |
| VALC2 | Target value |
| UNIT2 | Unit of Target value |
| MSEHL | Name of UOM |
| VALCS | SI unit value |
| UNITS | SI Unit |
| DIMID | Dimension |
| POINT | Measuring Ponit |
| KLART | Class type |
| ARTXT | Description-Class type |
| CLASS | Class |
| KLTXT | Description |
| STDCL | Indicator: Standard class |
| STATU | Status |
| ICON | Icon |
| ZAEHL | Item |
| DOKAR | Ty. |
| DOKNR | Document |
| DOKTL | DPt |
| DOKVR | Vr |
| DOSTX | Status |
| CVHIER | Hr |
| DKTXT | Description |
| KTXT | Object Desc. |

TABLE 7A
Production Resource/Tool Entity

| Attribute | Description |
|---|---|
| SFHNR | Production resources and Tools |
| SFHNR | Prod.resources.tool |
| FHKTX | Short text |
| BRGRU | Authorization Group |
| STATUS | Status |
| LOEKZ | Deletion flag |
| PLANV | Task list Usage |
| BASEH | Base unit of measuring |
| KZKBL | Load records |
| STOWK | Plant |
| STORT | Location |
| FGRU1 | Grouping key 1 |
| FGRU2 | Grouping key 2 |
| STEUF | Control key |
| STEUF_REF | Not Changeable-All functions |
| KTSCH | Standard text key |
| KTSCH_REF | Not Changeable-Std text key |
| MGFORM | Quantity formula |
| MGFORM_REF | Not Changeable-Qty formula |
| EWFORM | Usage value formula |
| EWFORM_REF | Not Changeable-Usage formula |
| BZOFFB | Ref. date for start |
| BZOFFB_REF | Not Changeable-Start date for setup |
| OFFSTB | Offset to start |
| EHOFFB | Offset unit |
| OFFSTB_REF | Not Changeable-Offset to start |
| BZOFFE | Ref. date for finish |
| BZOFFE_REF | Not Changeable-Start date for execution |
| OFFSTE | Offset to finish |
| EHOFFE | Offset unit |
| OFFSTE_REF | Not Changeable-Offset to finish |
| SFHNR | PRT |
| KLART | Class Type |
| ARTXT | Class Type description |
| CLASS | Class |
| KLTXT | Class Description |
| STDCL | Standard Class |
| STATU | Status |
| ICON | Icon |
| ZAEHL | Itm |
| UNIT1 | Unit of entry |
| MSEHL | Name of UOM |
| VALC2 | Target value |
| UNIT2 | Unit of Target value |
| MSEHL | Name of UOM |
| VALCS | SI unit value |
| UNITS | SI Unit |
| DIMID | Dimension |
| POINT | Measuring Ponit |
| KLART | Class type |
| ARTXT | Description-Class type |
| CLASS | Class |
| KLTXT | Description |
| STDCL | Indicator: Standard class |
| STATU | Status |
| ICON | Icon |
| ZAEHL | Item |
| DOKAR | Ty. |
| DOKNR | Document |
| DOKTL | DPt |
| DOKVR | Vr |
| DOSTX | Status |
| CVHIER | Hr |
| DKTXT | Description |
| KTXT | Object Desc. |

TABLE 8A
Task List Entity

| Attribute | Description |
|---|---|
| EQUNR | Equipment |
| TPLNR | Function Location |
| PLNNR | Group |
| PROFIDNETZ | Profile |
| AENNR | Change Number |
| STTAG | Key Date |
| HEAD1 | Group |
| PLNAL | Group Counter |
| KTEXT | Short text |
| TXTKZ | Long text Indicator |
| WERKS | Planning plant |
| ARBPL | Work center |
| WERKS | Work center plant |
| KTEXT | Description |
| VERWE | Usage |
| TXT | Description |
| VAGRP | Planner Group |
| TXT | Description |
| STATU | Status |
| TXT | Description |
| ANLZU | System Condition |
| ANLZUX | Text |
| STRAT | Maintenance strategy |
| KTEXT | Description |
| ISTRU | Assembly |
| MAKTX | Description |
| DELKZ | Deletion flag |
| SLWBEZ | Inspection points |
| KURZTEXT | Short text |
| EXTNUM | Ext. numbering |
| PLNAL | Ctr (task list item entity attributes) |
| KTEXT | TL Desc. (task list item entity attributes) |
| WERKS | Plnt (task list item entity attributes) |
| DELKZ | Del. (task list item entity attributes) |
| STRAT | Strategy (task list item entity attributes) |
| VERWE | Usage (task list item entity attributes) |
| VAGRP | PlGrp (task list item entity attributes) |
| STATU | Status (task list item entity attributes) |
| ANLZU | S (task list item entity attributes) |
| ISTRU | Assembly (task list item entity attributes) |
| SLWBEZ | IP (task list item entity attributes) |
| EXTNUM | EN (task list item entity attributes) |
| ENTRY_ACT | Entry (task list item entity attributes) |
| ENTRIES | No. Entry (task list item entity attributes) |
| HEAD1 | Task list key (task list operation entity attributes) |
| VORNR | OpAc (task list operation entity attributes) |
| UVORN | Sop (task list operation entity attributes) |
| ARBPL | Work Cntr (task list operation entity attributes) |
| WERKS | Plnt (task list operation entity attributes) |
| STEUS | Ctrl (task list operation entity attributes) |
| LTXA1 | Operation Description (task list operation entity |
| | attributes) |
| TXTKZ | LT (task list operation entity attributes) |
| ARBEI | Work (task list operation entity attributes) |
| ARBEH | Un. (task list operation entity attributes) |
| ANZZL | No. (task list operation entity attributes) |
| DAUNO | Duration (task list operation entity attributes) |
| DAUNE | Un. (task list operation entity attributes) |
| INDET | Calc (task list operation entity attributes) |
| PRZNT | Pct (task list operation entity attributes) |
| VERTN | Int. distr (task list operation entity attributes) |
| AUFKT | Fac (task list operation entity attributes) |
| LARNT | ActTyp (task list operation entity attributes) |
| KTSCH | StTextKy (task list operation entity attributes) |
| ISTRU | Assembly (task list operation entity attributes) |
| LOANZ | TT (task list operation entity attributes) |
| LOGRP | WG (task list operation entity attributes) |
| LOART | WT (task list operation entity attributes) |
| QUALF | Suit (task list operation entity attributes) |
| KZLGF | LFExtProc (task list operation entity attributes) |
| ANLZU | C (task list operation entity attributes) |
| BMVRG | OrdQuantity (task list operation entity attributes) |
| BMEIH | Unit (task list operation entity attributes) |
| PREIS | Net Price (task list operation entity attributes) |
| WAERS | Crcy (task list operation entity attributes) |
| PEINH | Per (task list operation entity attributes) |
| PLIFZ | PDT (task list operation entity attributes) |
| SAKTO | Cost Estim. (task list operation entity attributes) |
| MATKL | Matl Group (task list operation entity attributes) |
| EKGRP | PGr (task list operation entity attributes) |
| LIFNR | Vendor (task list operation entity attributes) |
| EKORG | POrg (task list operation entity attributes) |
| SORTL | Sort Term (task list operation entity attributes) |
| INFNR | Info Rec. (task list operation entity attributes) |
| EBELN | Purch.Doc. (task list operation entity attributes) |
| EBELP | Item (task list operation entity attributes) |
| SERV_PACKAGE | SP (task list operation entity attributes) |
| SLWID | Fld key (task list operation entity attributes) |
| ENTRY_ACT | Entry (task list operation entity attributes) |
| ENTRIES | No. Entry (task list operation entity attributes) |
| HEAD1 | Header line in a universal list (task list |
| | component entity attributes) |
| VORNR | Operation/Activity (task list component entity |
| | attributes) |
| LTXA1 | Short text (task list component entity attributes) |
| IDNRK | Material (task list component entity attributes) |
| MENGE | Quantity (task list component entity attributes) |
| MEINS | Un (task list component entity attributes) |
| RGEKZ | B (task list component entity attributes) |
| DISP | MRP/PR (task list component entity attributes) |
| MAKTX | Component description (task list component |
| | entity attributes) |
| POSTP | Ict (task list component entity attributes) |
| IHBGR | Assembly (task list component entity attributes) |
| SORTF | Sort (task list component entity attributes) |
| POSNR | Item (task list component entity attributes) |
| SANKA | Costing Relevance Indicator (task list component |
| | entity attributes) |
| SANIN | PM (task list component entity attributes) |
| STKKZ | PM Asy (task list component entity attributes) |
| RVREL | Sales (task list component entity attributes) |
| ERSKZ | Spare (task list component entity attributes) |
| BEIKZ | MPrvInd (task list component entity attributes) |
| SCHGT | Bulk (task list component entity attributes) |
| PSWRK | Iss.Pl. (task list component entity attributes) |
| WERKS | Plnt (task list component entity attributes) |
| EKGRP | PGp (task list component entity attributes) |
| PREIS | Price (task list component entity attributes) |
| WAERS | Crcy (task list component entity attributes) |
| PEINH | Pun (task list component entity attributes) |
| LIFZT | Del. Time (task list component entity attributes) |
| SAKTO | Cost Estim. (task list component entity attributes) |
| MATKL | Mat. Group (task list component entity attributes) |
| LGORT | SLoc (task list component entity attributes) |
| FMENG | Fixd (task list component entity attributes) |
| SILTY | BOM Ct (task list component entity attributes) |
| STLNR | BOM (task list component entity attributes) |
| STLAL | Alt. (task list component entity attributes) |
| VORNR | Operation (task list operation relationship entity |
| | attributes) |
| LTXA1 | Short text (task list operation relationship entity |
| | attributes) |
| VORNR | Operation (task list operation relationship entity |
| | attributes) |
| DAUER | Offset (task list operation relationship entity |
| | attributes) |
| ZEINH | Oun (task list operation relationship entity |
| | attributes) |
| AOBAR | Ty. (task list operation relationship entity |
| | attributes) |
| NCHKZ | Su. (task list operation relationship entity |
| | attributes) |
| LTXA1 | Operation Description (task list operation |
| | relationship entity attributes) |
| PRZNT | PO (task list operation relationship entity |
| | attributes) |
| PROVG | OI (task list operation relationship entity |
| | attributes) |
| KALID | ID (task list operation relationship entity |
| | attributes) |
| ARBPL | Work Ctr (task list operation relationship entity |
| | attributes) |
| WERKS | Plnt (task list operation relationship entity |
| | attributes) |

TABLE 8B
Task List Entity Business Rules

| Rule | | Comment |
|---|---|---|
| Control | | (Message |
| Number | Business Rule Description | Displayed) |
| TL0001 | Task List Group Name | No Message |
| | naming convention for | |
| | General Task Lists must be | |
| | followed | |
| TL0003 | Task List Header Description | No Message |
| | naming convention. It shall | |
| | not include any frequencies, | |
| | tag identifier or task list | |
| | origin types (RBI, RCM . . . ). | |
| TL0006 | The Task List Planner Group | No Message |
| | must be populated as it | |
| | identifies the owner who is | |
| | responsible for the | |
| | maintenance of the Task List. | |
| | This is particularly useful | |
| | where authorization control | |
| | is necessary. It will also help | |
| | the Task List Maintainer to | |
| | use this key to search for all | |
| | the Task Lists for which they | |
| | are responsible. | |
| TL0007 | Task List Status must be | No Message |
| | populated. The status key | |
| | indicates the processing | |
| | status of a task list. For | |
| | example, you can indicate | |
| | whether the Task List is still | |
| | in the creation phase or has | |
| | already been released. | |
| TL0008 | Task List Header System | No Message |
| | Condition must be left blank. | |
| | This field shall not be used at | |
| | the Task List Header level. | |
| | System Condition field at | |
| | Task List Operation level | |
| | will be used. | |
| TL0009 | Inspection Point must be | No Message |
| | populated for Assurance | |
| | Task Lists | |
| TL0014 | Task List Operation | No Message |
| | Description must start with | |
| | the frequency indicator | |
| TL0015 | Task List Workers Required | No Message |
| | must be populated. The | |
| | number of capacities is an | |
| | estimate on the number of | |
| | people required to execute | |
| | the Operation. This is useful | |
| | for the Work Preparer and | |
| | Scheduler during capacity | |
| | planning. | |
| TL0016 | Task List Operation Normal | No Message |
| | Duration must be populated. | |
| | The duration of work is an | |
| | estimate on the ‘time’ | |
| | required for ‘one person’ to | |
| | execute and complete the | |
| | particular Operation for a | |
| | single object. | |
| | The total Work Hours | |
| | required for the Operation is | |
| | calculated automatically, by | |
| | Workers required x Duration | |
| | of work. | |
| TL0017 | Task List Operation System | No Message |
| | Condition must be populated. | |
| | The Work Order generated | |
| | from this Task List will | |
| | inherit this information at the | |
| | Operation level. | |
| TL0022 | Task List Operation | No Message |
| | Production Resource and | |
| | Tools (PRT) should be | |
| | assigned. | |
| TL0026 | Task List Operation | No Message |
| | Inspection Characteristics. | |
| | Mandatory for QM (Task | |
| | List with Inspection Point) | |
| TL0029 | Task List Group Name must | No Message |
| | not contain special characters | |
| TL0030 | Check that if a Class is | No Message |
| | assigned to a Task List, at | |
| | least one classification is | |
| | populated | |
| TL0034 | Task List Operation | No Message |
| | execution factor should | |
| | always be ‘1’ | |
| TL0035 | Task List Operation | No Message |
| | calculation key is | |
| | recommended to be ‘2’. It is | |
| | recommended that the total | |
| | Work Hours required for the | |
| | Operation is calculated | |
| | automatically, by selecting | |
| | the Calculation Key of ‘2’, | |
| | where ‘Work = Number of | |
| | Workers Required x | |
| | Duration’ | |

TABLE 9A
Maintenance Item Entity

| Attribute | Description |
|---|---|
| AEDAT | Changed on |
| AEKNZ | Change Indicator |
| AENAM | Name of person who changed object |
| ANLZU | Syst. Condition |
| APFKT | Execution factor for whole task list |
| AUART | Order Type |
| AUFNR | Settlement Order |
| BAUTL | Assembly |
| BSTNR | Purchase Order Number |
| DEVICEID | Additional Device Data |
| EQUNR | Maintenance Plan Number |
| ERKNZ | Creation Indicator |
| ERNAM | Name of person who created the object |
| ERSDT | Date of creation |
| GSBER | Business Area |
| ILART | Maintenance activity type |
| ILOAI | ILOA Individual |
| ILOAN | Location and account assignment for technical object |
| INACT | Indicator that maintenance item is inactive |
| IND_ABRVO | Indicator showing settlement rule maintained |
| IWERK | Maintenance Planning Plant |
| KDAUF | Sales Document |
| LANGULNTX | Language key of the long text |
| LAUFN | Order number |
| LBLNI | Entry sheet number |
| LTKNZ | Long Text Indicator |
| MITYP | Maintenance item category |
| NETPR | Net Price (Note: Curr./UOM = WAERS) |
| OBJNR | Object number |
| OBKNR | Object list number |
| PACKNO | Package number |
| PLNAL | Group counter |
| PLNNR | Key for Task List Group |
| PLNTY | Task list type |
| PSPEL | Work Breakdown Structure Element (WBS) |
| PSTXT | Item short text |
| QMART | Notification Type |
| QMKAT | Catalog Type-coding |
| QMNUM | Notification No |
| SCRRENTY | SCREEN TYPE: for order-order category (see domain) |
| SERIALNR | Serial Number |
| SERMAT | Material Number |
| STATUS | Maintenance Item Status |
| STD_AVO | Number of the task list node |
| STD_NETZ | Key for task list group |
| TASK_DETE | Automatic task determination in the notification |
| WAERS | Currency key |
| WPPOS | Item in the maintenance plan |

TABLE 9B
Maintenance Item Entity Business Rules

| Rule | | |
|---|---|---|
| Control | | Comment |
| Number | Business Rule Description | (Message Displayed) |
| MI0001 | Maintenance Item Description. | Description should not |
| | In Maintenance item, | contain tag identifier and |
| | Description should contain | frequency information |
| | concatenation of description | |
| | of Equipment and Task | |
| | description. If it contains tag | |
| | identifier (ILOA-EQFNR | |
| | sort field) or Frequency | |
| | (Strategy RMIPM-WSTRA) | |
| | information, it should throw | |
| | error. | |
| MI0002 | Reference Object: Functional | Given Function Location |
| | Location and Equipment | hierarchy level not |
| | 1) Functional Location | permitted |
| | (RIWO1-TPLNR) must be | |
| | assigned at the righ tlevel in the | |
| | hierarchy to accurately record | |
| | the cost and history at the level. | |
| | 2) The Task List assigned to | Task list should be |
| | the Maintenance Item shall | maintained with Function |
| | be relevant to the Functional | location master. |
| | Location task list specified. | |
| | Strategy data (PLKOD- | |
| | STRAT) for both task list and | |
| | Function location should be | |
| | same. | |
| | 3) The Reference Functional | WBS is mandatory field in |
| | Location assigned shall have a | given Floc/Equip so as to |
| | valid WBS element to enable | derive in maintenance item. |
| | cost capture. | |
| | 4) When a high level Functional | Equipment needs to be |
| | Location is assigned, such as | entered in maintenance item |
| | Facility or System level, a | if floc is high level. |
| | detailed Object List could be | |
| | included. | |
| | 5) Equipment shall be included | WBS is mandatory field so |
| | where it is installed at the | as to derive in maintenance |
| | Functional Location to enable | item. |
| | cost and history recording at | |
| | this level. | |
| MI0005 | Order Type | Order type for Maintenance |
| | While creating Maintenance | order and Maintenance Item |
| | item correct Order type | is different for this order. |
| | should be maintained as same | |
| | will be used to determine | |
| | which type order will be created | |
| | with this Maintenance item. | |
| MI0007 | Priority | Assignment for field |
| | Assignment of the Priority | Priority with field |
| | should be in relation to the | Compliance Category is not |
| | Compliance Category (Z | correct. |
| | field) assignment in the Task | |
| | List Operations. | |

TABLE 10A
Maintenance Plan Entity

| Attribute | Description |
|---|---|
| ABRHO | Scheduling Period |
| BEGRU | Authorization Group |
| CALL_CONF | Completing Predecessor |
| DATUM | Key Date |
| FABKL | Factory Calendar |
| HORIZ | Call Horizon |
| HUNIT | Unit in scheduling interval |
| MPTYP | Maint. Plan cat. (Note: Required Entry) |
| OFFS1 | Maintenance package offset |
| PLAN_SORT | Sort field |
| SFAKT | Cycle modification factor |
| STADT | Start of cycle (Start date) |
| TONEG | Tolerance (−) |
| TOPOS | Tolerance (+) |
| VSNEG | Shift Factor Early Compl. |
| VSPOS | Shift Factor for Late Completion |
| WSTRA | Strategy (Note: Required Entry) |
| ZEIEH | Unit for the performance of maintenance tasks |
| ZYKL1 | Maintenance cycle |
| AEDAT | Changed on (Maintenance Item Attributes) |
| AEKNZ | Change Indicator (Maintenance Item Attributes) |
| AENAM | Name of person who changed object (Maintenance |
| | Item Attributes) |
| ANLZU | Syst. Condition (Maintenance Item Attributes) |
| APFKT | Execution factor for whole task list (Maintenance Item |
| | Attributes) |
| AUART | Order Type (Maintenance Item Attributes) |
| AUFNR | Settlement Order (Maintenance Item Attributes) |
| BAUTL | Assembly (Maintenance Item Attributes) |
| BSTNR | Purchase Order Number (Maintenance Item Attributes) |
| DEVICEID | Additional Device Data (Maintenance Item Attributes) |
| EQUNR | Maintenance Plan Number (Maintenance Item |
| | Attributes) |
| ERKNZ | Creation Indicator (Maintenance Item Attributes) |
| ERNAM | Name of person who created the object (Maintenance |
| | Item Attributes) |
| ERSDT | Date of creation (Maintenance Item Attributes) |
| GSBER | Business Area (Maintenance Item Attributes) |
| ILART | Maintenance activity type (Maintenance Item |
| | Attributes) |
| ILOAI | ILOA Individual (Maintenance Item Attributes) |
| ILOAN | Location and account assignment for technical object |
| | (Maintenance Item Attributes) |
| INACT | Indicator that maintenance item is inactive |
| | (Maintenance Item Attributes) |
| IND_ABRVO | Indicator showing settlement rule maintained |
| | (Maintenance Item Attributes) |
| IWERK | Maintenance Planning Plant (Maintenance Item |
| | Attributes) |
| KDAUF | Sales Document (Maintenance Item Attributes) |
| LANGULNTX | Language key of the long text (Maintenance Item |
| | Attributes) |
| LAUFN | Order number (Maintenance Item Attributes) |
| LBLNI | Entry sheet number (Maintenance Item Attributes) |
| LTKNZ | Long Text Indicator (Maintenance Item Attributes) |
| MITYP | Maintenance item category (Maintenance Item |
| | Attributes) |
| NETPR | Net Price (Note: Curr./UOM = WAERS) (Maintenance |
| | Item Attributes) |
| OBJNR | Object number (Maintenance Item Attributes) |
| OBKNR | Object list number (Maintenance Item Attributes) |
| PACKNO | Package number (Maintenance Item Attributes) |
| PLNAL | Group counter (Maintenance Item Attributes) |
| PLNNR | Key for Task List Group (Maintenance Item |
| | Attributes) |
| PLNTY | Task list type (Maintenance Item Attributes) |
| PSPEL | Work Breakdown Structure Element (WBS) |
| | (Maintenance Item Attributes) |
| PSTXT | Item short text (Maintenance Item Attributes) |
| QMART | Notification Type (Maintenance Item Attributes) |
| QMKAT | Catalog Type-coding (Maintenance Item Attributes) |
| QMNUM | Notification No (Maintenance Item Attributes) |
| SCRRENTY | SCREEN TYPE: for order-order category (see domain) |
| | (Maintenance Item Attributes) |
| SERIALNR | Serial Number (Maintenance Item Attributes) |
| SERMAT | Material Number (Maintenance Item Attributes) |
| STATUS | Maintenance Item Status (Maintenance Item |
| | Attributes) |
| STD_AVO | Number of the task list node (Maintenance Item |
| | Attributes) |
| STD_NETZ | Key for task list group (Maintenance Item Attributes) |
| TASK_DETE | Automatic task determination in the notification |
| | (Maintenance Item Attributes) |
| WAERS | Currency key (Maintenance Item Attributes) |
| WPPOS | Item in the maintenance plan (Maintenance Item |
| | Attributes) |

TABLE 10B
Maintenance Plan Entity Business Rules

| Rule | | |
|---|---|---|
| Control | | Comment |
| Number | Business Rule Description | (Message Displayed) |
| MP0001 | Maintenance Strategy | Maintenance strategy |
| | In Maintenance Plan, for | is mandatory for time |
| | time or counter based plans | or counter based plan. |
| | (strategy based as per | |
| | requirement), Maintenance | |
| | Strategy is mandatory and for | |
| | CIMS Task list (Single/ | |
| | Multiple cycle as per | |
| | requirement), Maintenance | |
| | strategy is kept blank. | |
| MP0002 | Maintenance Plan Call | Call Horizon is |
| | Control Parameters | mandatory |
| | In Maintenance Plan, field | |
| | Call horizon (RMIPM- | |
| | HORIZ) is mandatory | |
| | BRF rule can be used. | |
| MP0003 | Maintenance Plan Scheduling | Scheduling Indicator |
| | Indicator | should be based on |
| | In Maintenance Plan, field | strategy/plan cycle |
| | Scheduling Indicator should | (single/multiple) |
| | be derived based on strategy/ | |
| | plan cycle (single/multiple). | |
| MP0004 | Maintenance Plan Start | Schedule date is |
| | Scheduling Date | mandatory |
| | In Maintenance Plan, field | |
| | Scheduling date (RMIPM- | |
| | STADT) should be defaulted | |
| | as today's system date and | |
| | can be changed as per | |
| | requirement. | |
| MP0005 | Maintenance Plan Sort Field | Sort field needs to be |
| | In Maintenance Plan, Sort | populated with the |
| | field needs to be populated | prefix of 2 digits of |
| | with the prefix of 2 digits | country code or OU |
| | country code or OU identifier | identifier |
| | e.g. ‘NO’ for Norway. | |
| | Other values are defined to | |
| | select Plans with Call object | |
| | days, e.g. ‘NO-90D’ | |
| | represents plans for which | |
| | the Date Monitoring Program | |
| | shall be run monthly to | |
| | generate work orders that are | |
| | due in the next 90 days. | |
| MP0006 | Maintenance Plan | Authorization group |
| | Authorization Group Field | needs to be populated |
| | In Maintenance Plan, | with the prefix of 2 |
| | Authorization group needs to | digits of country code |
| | be populated with the prefix | or OU identifier |
| | of 2 digits country code or | |
| | OU identifier. | |
| MP00017 | Task List Maintenance | Maintenance strategy |
| | Strategy | for Maintenance Item |
| | In Maintenance Plan, field | and Maintenance plan |
| | Maintenance strategy should | should be same. |
| | be same for Maintenance | |
| | Item and Maintenance plan. | |
| MP00018 | Maintenance Item in | Maintenance Plan |
| | Maintenance Plan | should have 1 |
| | In Maintenance Plan, | Maintenance Item |
| | Maintenance Plan should | attached. Maintenance |
| | have 1 Maint. Item attached, | Item should have a task |
| | Maint. Item should have a | list and Task list |
| | task list and Task list should | should have 1 package |
| | have 1 package attached to it. | attached to it. |

What is claimed is:

1. A system for ensuring the integrity of enterprise asset management data, the system comprising:
a computer readable storage media;
an enterprise asset management data store contained on the computer readable storage media, the enterprise asset management data store comprising an enterprise asset management data entity of an entity type selected from the group consisting of:
an equipment entity type;
a functional location entity type;
an MRO bill of material entity type;
a work center entity type;
a catalog entity type;
a maintenance item entity type;
a maintenance plan entity type;
a measuring points entity type;
a production resource/tool entity type; and
a task list entity type;
program instructions stored on the computer readable storage media that, when executed by a processing system, direct the processing system to:
receive, from a requester work queue having a requester role, an update request for a change to a particular enterprise asset data element, wherein the change is stored in a temporary data repository;
route the update request to one or more specialist work queue, each of the one or more specialist work queue having a specialist role and a first set of update validation rules for validating the update request, and
when the update request violates a subset of the first set of update validation rules, modify the update request or return the update request to the requester work queue, and
when the update request conforms with all of the first set of update validation rules, route the update request to one or more steward work queue, each of the one or more steward work queue having a steward role and a second set of update validation rules for validating the update request, and
when the update request violates a subset of the second set of update validation rules, return the update request to a prior work queue, and
when the update request conforms with all of the second set of update validation rules, route the update request to a backend processing work queue, the backend processing work queue having a backend processing authorization role, and update the enterprise asset management data store with the change.

2. The system of claim 1, wherein a particular enterprise asset data entity of the equipment entity type comprises data describing a single physical object that is maintained as an autonomous unit.

3. The system of claim 1, wherein a particular enterprise asset data entity of the functional location entity type comprises data describing a place at which a maintenance task is performed, wherein the place is described according to functional, process-oriented, or spatial criteria.

4. The system of claim 1, wherein a particular enterprise asset data entity of the MRO bill of material entity type comprises data describing a quantity, a unit of measure, and a description of one or more components that make up a physical object.

5. The system of claim 1, wherein a particular enterprise asset data entity of the work center entity type comprises data describing where and when an activity is performed.

6. The system of claim 1, wherein the first set of update validation rules and the second set of update validation rules are comprised of rules associated with one or more of the entity types.

7. The system of claim 1, wherein the update request for the change to the particular enterprise asset management data elements comprises one or more of: adding a new entity, modifying an attribute of an existing entity, and deleting a particular entity.

8. The system of claim 1, wherein the routing to a plurality of specialist work queues is performed in series or in parallel.

9. The system of claim 1, wherein the routing to a plurality of steward work queues is performed in series or in parallel.

10. The system of claim 1, further comprising program instructions stored on the computer readable storage media that, when executed by the processing system:
render an interface for defining a unique work queue routing workflow; and
store the unique work queue routing workflow on the enterprise asset management data store.

11. A method for ensuring the integrity of enterprise asset management data within a data store, the method comprising:
receiving, from a requester work queue having a requester role, an update request for a change to a particular enterprise asset data element of an enterprise asset management data entity stored on the data store, wherein the change is stored in a temporary data repository, wherein the enterprise asset management data entity has an entity type selected from the group consisting of an equipment entity type, a functional location entity type, an MRO bill of material entity type, a work center entity type, a catalog entity type, a maintenance item entity type, a maintenance plan entity type, a measuring points entity type, a production resource/tool entity type, and a task list entity type;
routing the update request to one or more specialist work queue, each of the one or more specialist work queue having a specialist role and a first set of update validation rules for validating the update request, and
when the update request violates a subset of the first set of update validation rules, modifying the update request or returning the update request to the requester work queue, and
when the update request conforms with all of the first set of update validation rules, routing the update request to one or more steward work queue, each of the one or more steward work queue having a steward role and a second set of update validation rules for validating the update request, and
when the update request violates a subset of the second set of update validation rules, returning the update request to a prior work queue, and
when the update request conforms with all of the second set of update validation rules, routing the update request to a backend processing work queue, the backend processing work queue having a backend processing authorization role, and updating the data store with the change.

12. The method of claim 11, wherein a particular enterprise asset data entity of the equipment entity type comprises data describing a single physical object that is maintained as an autonomous unit.

13. The method of claim 11, wherein a particular enterprise asset data entity of the functional location entity type comprises data describing a place at which a maintenance task is performed, wherein the place is described according to functional, process-oriented, or spatial criteria.

14. The method of claim 11, wherein a particular enterprise asset data entity of the MRO bill of material entity type comprises data describing a quantity, a unit of measure, and a description of one or more components that make up a physical object.

15. The method of claim 11, wherein a particular enterprise asset data entity of the work center entity type comprises data describing where and when an activity is performed.

16. The method of claim 11, wherein the first set of update validation rules and the second set of update validation rules are comprised of rules associated with one or more of the entity types.

17. The method of claim 11, wherein the update request for the change to the particular enterprise asset management data elements comprises one or more of: adding a new entity, modifying an attribute of an existing entity, and deleting a particular entity.

18. The method of claim 11, wherein the routing to a plurality of specialist work queues is performed in series or in parallel.

19. The method of claim 11, wherein the routing to a plurality of steward work queues is performed in series or in parallel.

20. The method of claim 11, further comprising:
rendering an interface for defining a unique work queue routing workflow; and
storing the unique work queue routing workflow on the data store.
